(19) United States
(12) Patent Application Publication
(10) Pub. No.: US 2025/0305169 A1
(43) Pub. Date: Oct. 2, 2025

(54) BYPASSABLE CIRCUITRY ARRANGEMENTS FOR ELECTROLYZERS WITH BYPASSABLE BIPOLAR PLATES

(71) Applicant: Analog Devices International Unlimited Company, Limerick (IE)

(72) Inventors: Joern Oppenhaeuser, Butzbach (DE); Alessandro Salvucci, Belmont, MA (US); Radhika Marathe, Lexington, MA (US); Colin Keeley Swanson, Arlington, MA (US); Uwe Broeckelmann, Issing (DE)

(21) Appl. No.: 18/618,984

(22) Filed: Mar. 27, 2024

(51) Int. Cl. C25B 15/02; C25B 1/04

(52) U.S. Cl. CPC C25B 15/02; C25B 1/04

(57) ABSTRACT

Various examples are directed to an electrolyzer system comprising an electrolyzer stack and a control circuit. The electrolyzer stack may comprise a first bipolar plate, a second bipolar plate parallel to the first bipolar plate and a third bipolar plate parallel to the second bipolar plate. The electrolyzer stack may further comprise a first switch electrically coupled between the first bipolar plate and the second bipolar plate to selectively electrically couple the first bipolar plate and the second bipolar plate, and a second switch electrically coupled between the first bipolar plate and the second bipolar plate to selectively electrically coupled the second bipolar plate and the third bipolar plate. The controller circuit may be configured to actuate the first switch to electrically couple the first bipolar plate and the second bipolar plate.

### FIELD OF THE DISCLOSURE

This document pertains generally, but not by way of limitation, to electrolysis cells.

### BACKGROUND

Electrolyzers are used to generate hydrogen from electricity and water. Electrolyzer cells may receive water and hydrogen. The electrolyzer cells may utilize the electrical energy to split the water into its constituent elements oxygen, and hydrogen. Electrolyzer cells may be arranged in stacks to increase capacity. Similar devices referred to as fuel cells are also used to convert chemical energy (usually from hydrogen) to electrical energy.

### OVERVIEW

This disclosure describes, among other things, techniques for operating electrolysis cells.

Example 1 is an electrolyzer system comprising: an electrolyzer stack, the electrolyzer stack comprising: a first bipolar plate; a second bipolar plate parallel to the first bipolar plate; a third bipolar plate parallel to the second bipolar plate; a first switch electrically coupled between the first bipolar plate and the second bipolar plate to selectively electrically couple the first bipolar plate and the second bipolar plate; and a second switch electrically coupled between the second bipolar plate and the third bipolar plate to selectively electrically couple the second bipolar plate and the third bipolar plate; and a controller circuit, the controller circuit configured to actuate the first switch to electrically couple the first bipolar plate and the second bipolar plate.

In Example 2, the subject matter of Example 1 optionally includes the electrolyzer stack having a first edge and a second edge opposite the first edge, the first switch being positioned between the first bipolar plate and the second bipolar plate at the first edge, and the second switch being positioned between the second bipolar plate and the third bipolar plate at the second edge.

In Example 3, the subject matter of Example 2 optionally includes the electrolyzer stack further comprising an extension of a flow channel positioned between the first bipolar plate and the second bipolar plate at the second edge.

In Example 4, the subject matter of any one or more of Examples 2-3 optionally include the electrolyzer stack further comprising a material that is thermally dissipative and electrically insulating positioned between the first bipolar plate and the second bipolar plate at the second edge.

In Example 5, the subject matter of any one or more of Examples 2-4 optionally include the electrolyzer stack further comprising a gasket positioned between the first bipolar plate and the second bipolar plate at the first edge, the first switch being positioned outside the gasket.

In Example 6, the subject matter of any one or more of Examples 1-5 optionally include the first switch being mechanically coupled to the first bipolar plate using at least one of a conductive adhesive, a solder, or a metal mesh.

In Example 7, the subject matter of any one or more of Examples 5-6 optionally include the first switch being mechanically coupled to a portion of the first bipolar plate using solder, the portion of the first bipolar plate comprising a coating.

In Example 8, the subject matter of any one or more of Examples 1-7 optionally include the first switch being positioned between the first bipolar plate and the second bipolar plate, the first switch comprising a resilient structure arranged to exert a first force against the first bipolar plate and a second force against the second bipolar plate.

In Example 9, the subject matter of any one or more of Examples 1-8 optionally include the electrolyzer stack further comprising: a first conductive foil electrically coupled to the first bipolar plate; a second conductive foil electrically coupled to the second bipolar plate; and an insulator material positioned between the first conductive foil and the second conductive foil, the first switch being electrically coupled between the first conductive foil and the second conductive foil.

In Example 10, the subject matter of Example 9 optionally includes a distance between the first conductive foil and the second conductive foil at the first switch being greater than a distance between the first bipolar plate and the second bipolar plate.

In Example 11, the subject matter of any one or more of Examples 1-10 optionally include the first switch comprising a mechanical actuator member arranged to be selectively positioned between the first bipolar plate and the second bipolar plate.

In Example 12, the subject matter of any one or more of Examples 1-11 optionally include the electrolyzer stack further comprising a printed circuit board, the first switch being mounted on the printed circuit board.

In Example 13, the subject matter of Example 12 optionally includes the printed circuit board comprising a first contact on a first side of the printed circuit board and a second contact on a second side of the printed circuit board, the printed circuit board being positioned between the first bipolar plate and the second bipolar plate with the first contact electrically coupled to the first bipolar plate and the second contact electrically coupled to the second bipolar plate.

In Example 14, the subject matter of any one or more of Examples 12-13 optionally include a connector to electrically couple the printed circuit board to the first bipolar plate and the second bipolar plate.

In Example 15, the subject matter of any one or more of Examples 12-14 optionally include the printed circuit board being a flexible printed circuit board, a first portion of the printed circuit board being between the first bipolar plate and the second bipolar plate, and a second portion of the printed circuit board not being between the first bipolar plate and the second bipolar plate.

In Example 16, the subject matter of any one or more of Examples 12-15 optionally include the printed circuit board comprising a first contact on a first side, the first switch being mounted to the printed circuit board on a second side of the printed circuit board, the first contact being electrically coupled to the first bipolar plate and at least a portion of the first switch being electrically coupled to the second bipolar plate.

In Example 17, the subject matter of any one or more of Examples 1-16 optionally include the first switch comprising a packaging having a first side and a second side, a first terminal being positioned on the first side and in contact with the first bipolar plate and a second terminal being positioned on the second side and in contact with the second bipolar plate.

In Example 18, the subject matter of any one or more of Examples 1-17 optionally include the controller circuit being programmed to perform operations comprising: closing the first switch and the second switch; after closing the first switch and the second switch, receiving an indication that water in the electrolyzer stack has reached a threshold temperature; and opening the first switch and the second switch.

Example 19 is an electrolyzer system comprising: an electrolyzer stack, the electrolyzer stack comprising: a first bipolar plate; a second bipolar plate parallel to the first bipolar plate; a third bipolar plate parallel to the second bipolar plate; first means for selectively electrically coupling the first bipolar plate and the second bipolar plate; and second means for selectively electrically coupling the second bipolar plate and the third bipolar plate.

In Example 20, the subject matter of any one or more of Examples 18-19 optionally include controller circuit being programmed to perform operations comprising: configuring the first means to electrically couple the first bipolar plate and the second bipolar plate; configuring the second means to electrically couple the second bipolar plate and the third bipolar plate; receiving an indication that water in the electrolyzer stack has reached a threshold temperature; after receiving the indication that water in the electrolyzer stack has reached the threshold temperature, configuring the first means to remove electrical coupling between the first bipolar plate and the second bipolar plate; and after receiving the indication that water in the electrolyzer stack has reached the threshold temperature, configuring the second means to remove electrical coupling between the second bipolar plate and the third bipolar plate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an electrolyzer system including parallel connected electrolyzer cells, in accordance with various embodiments.

FIG. 2 is a block diagram of an example of an electrolyzer system including parallel connected electrolyzer cells, in accordance with various embodiments.

FIG. 3 is a block diagram of an example of an electrolyzer system including parallel connected electrolyzer cells, in accordance with various embodiments.

FIG. 4 is a block diagram of an example of a bipolar plate, in accordance with various embodiments.

FIG. 5A is a block diagram of an example of an electrolyzer system including series connected electrolyzer cells, in accordance with various embodiments.

FIG. 5B is a block diagram of an example of an electrolyzer system including series connected electrolyzer cells coupled to a solar photovoltaic cell (PV), in accordance with various embodiments.

FIG. 6 is a block diagram of an example of an electrolyzer system including series connected electrolyzer cells, in accordance with various embodiments.

FIGS. 7A and 7B are block diagrams of examples of a bipolar plate, in accordance with various embodiments.

FIG. 8 is a diagram showing one example of a view of a portion of a bipolar plate comprising example bypass circuitry including example switches.

FIG. 9 is a diagram showing one example of a view of a portion of a bipolar plate comprising example bypass circuitry including an example switch.

FIGS. 10 and 11 are diagrams showing a cross-sectional view of a portion of an electrolyzer stack comprising three bipolar plates.

FIG. 12 is a diagram showing one example view of a bipolar plate comprising example bypass circuitry including example switches.

FIG. 13 is a diagram showing another example view of a bipolar plate comprising example bypass circuitry including example switches.

FIG. 14 is a diagram showing a cross-sectional view of a portion of one example of an electrolyzer stack comprising four bipolar plates.

FIG. 15 is a diagram showing a cross-sectional view of a portion of one example of an electrolyzer stack comprising eight bipolar plates.

FIG. 16 is a diagram showing one example of an electrolyzer stack including bypass circuitry.

FIG. 17 is a diagram showing one example of a switch comprising a resilient contact.

FIG. 18 is a diagram showing one example of a switch comprising a resilient contact assembly comprising a first contact panel and a second contact panel.

FIG. 19 is a diagram showing a cross-sectional view of one example of a portion of an electrolyzer stack comprising five bipolar plates.

FIG. 20 is a diagram showing one example of an electrolyzer cell comprising bypass circuitry including a switch positioned outside of bipolar plates.

FIG. 21 is a diagram showing another example of an electrolyzer cell comprising bypass circuitry including a switch position outside of bipolar plates.

FIG. 22 is a diagram showing selected components from an example electrolyzer stack including bipolar plates with fan out portions.

FIG. 23 is a diagram showing selected components from an example electrolyzer stack including bipolar plates.

FIG. 24 is a diagram showing selected components from another example electrolyzer stack including bipolar plates.

FIG. 25 is a diagram showing a cross-sectional view of a portion of an example electrolyzer stack comprising four bipolar plates and including bypass circuitry mounted on respective flexible printed circuit boards.

FIG. 26 is a diagram showing a cross-sectional view of a portion of an electrolyzer stack comprising four bipolar plates and including bypass circuitry mounted on respective rigid printed circuit boards.

FIG. 27 is a diagram showing a cross-sectional view of a portion of another example electrolyzer stack comprising four bipolar plates.

FIGS. 28 and 29 show an example switch that may be used to implement bypass circuitry, as described herein.

FIG. 30 is a flow diagram depicting example process for operating an electrolyzer, in accordance with various embodiments.

FIG. 31 is a flow diagram depicting example process for operating an electrolyzer coupled to a solar PV, in accordance with various embodiments.

FIG. 32 is a block diagram illustrating an example of a machine upon which one or more embodiments may be implemented.

### DETAILED DESCRIPTION

This disclosure describes, among other things, techniques to configure an electrolyzer or hydrolyzer to generate hydrogen and/or oxygen.

An electrolyzer typically includes one or more electrolyzer cells. Each electrolyzer cell has three component parts: an electrolyte and two electrodes (a cathode and an anode). The electrolyte is usually a solution of water or other solvents in which ions are dissolved. Molten salts such as sodium chloride are also electrolytes. When driven by an external voltage applied to the electrodes, the ions in the electrolyte are attracted to an electrode with the opposite charge, where charge-transferring (also called faradaic or redox) reactions can take place. Only with an external electrical potential (i.e., voltage) of correct polarity and sufficient magnitude can an electrolyzer cell decompose a normally stable, or inert, chemical compound in the solution. The electrical energy provided can produce a chemical reaction, which would not occur spontaneously otherwise. Water, particularly when ions are added (salt water or acidic water), can be electrolyzed (subject to electrolysis). When driven by an external source of voltage, H+ ions flow to the cathode to combine with electrons to produce hydrogen gas in a reduction reaction. Likewise, OH− ions flow to the anode to release electrons and an H+ ion to produce oxygen gas in an oxidation reaction.

A system that generates hydrogen through electrolysis is called an electrolyzer or a hydrolyzer. A power generation system may produce a high voltage (for example, between about 50V and about 300V or more) and a high current (for example, between about 100 A and about 5000 A or more) that is provided to a cell stack that includes electrolyzer cells that each include an electrolyte and two electrodes. With water as the other input, the cell stack produces hydrogen and oxygen as outputs. If the source of power is a renewable such as solar, wind, or hydroelectric, then the entire cycle is completely carbon free. Electrolyzer cells are typically electrically connected in series. However, such configurations have several shortcomings. For example, one challenge of electrolyzers is durability. As electrolyzer manufacturers scale to thinner cell membranes in order to increase the maximum stack DC current, the levelized cost of hydrogen production may be reduced. However, cell reliability may also suffer as thinner membranes may be more likely to develop defects such as pinholes. Furthermore, scaling down of catalyst/PTL loadings to drive down stack capital costs exposes the stack to reduced efficiency due to catalyst/PTL degradation.

In addition, configuring the electrolyzers in series limits the scalability of the overall system, because adding or replacing electrolyzer cells introduces additional challenges. For example, if one electrolyzer cell in the electrolyzer breaks down, the power distribution through the system to other cells can be impacted and the overall system may also stop functioning. If the failed cell loses electrical conductivity, the electrical conductivity of the stack as a whole may be compromised. Also, when the cells are in a series configuration, it may not be practical to replace individual cells. Accordingly, when one cell fails then the entire stack may fail.

According to the disclosed embodiments, a novel and resource efficient approach to operating and configuring electrolyzers is provided. The disclosed approach configures cells of the electrolyzers through an electrical series connection and provides bypass circuitry on one or more plates of the electrolyzer to electrically remove any given cell from the electrical series connection while maintaining flow of current through remaining cells. In this way, performance on a per cell/bipolar plate basis can be managed, which can be used to control parameters of other cells/bipolar plates of the electrolyzer. Also, configuring the electrolyzer cells in this manner makes the system highly scalable because adding cells to the system becomes trivial through the use of additional bypass circuitry, and when one cell/bipolar plate breaks down, that cell/bipolar plate can be electrically removed so that power distribution, such as voltage, delivered to other cells/bipolar plates can be maintained with minimal change. In some cases, the bypass circuitry, rather than electrically remove the cell from the series connection, reduces the current/voltage that flows between two cells. To do so, in some embodiments, the bypass circuitry includes multiple electronic connections, and the bypass circuitry activates a particular portion of the electronic connections (e.g., closes a subset of switches) to reduce the overall current that flows from one bipolar plate of a given cell to another plate of the cell by shunting a portion of the current between the bipolar plates of the given cell.

In some examples, each cell is associated with a local monitoring system that includes an analog-to-digital converter (ADC). For example, the local monitoring system can be implemented on each individual cell, in which case each local monitoring system monitors its own individual cell performance. In other implementations, the local monitoring system is implemented by a central controller (in which case the local monitoring system is a central monitoring system) that communicates with each individual cell to obtain the performance measurement parameters. Specifically, the local monitoring system (or central monitoring system) measures one or more analog values to generate a set of one or more parameters in analog or digital form. The local/central monitoring system uses the set of one or more parameters to generate a model that represents the performance or failure of the associated cell and/or a collection of cells. The ADC implemented on the particular cell can measure voltages, currents, and temperature at various locations in the cell to generate the one or more parameters. The central monitoring system can gather one or more parameters from all of the cells in a system, or the central monitoring system can access data from many electrolyzer systems in the cloud.

In some cases, a central monitoring system, such as a server or control circuitry accessible over the Internet on the cloud, monitors the voltage and/or current across each cell, and the current, temperature, and/or other parameters such as gas and fluid flow. The information is used to monitor the performance of the system and to estimate the state-of-health of each cell on an individual basis. The performance and health estimation system may employ artificial intelligence or machine learning techniques (AI/ML) or other algorithmic techniques to process data from one or many cells. The AI/ML techniques can be trained to predict performance and/or failure on an individual cell basis based on training data. In this way, individual electrolyzer cells can be bypassed or have their respective current/voltage reduced using their respective bypass circuitries to optimize performance and increase durability of the cell and electrolyzer system.

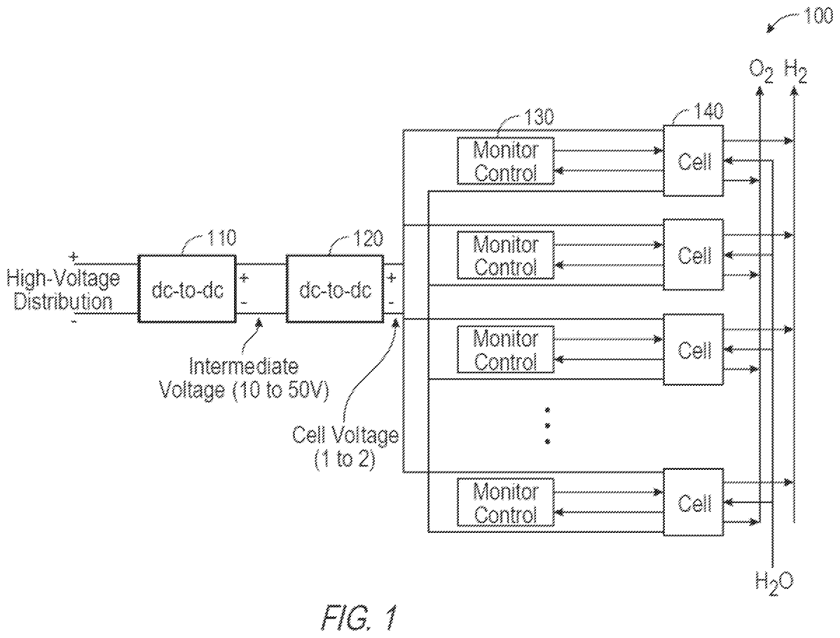

FIG. 1 is a block diagram of an example of an electrolyzer system 100 that includes cells coupled to each other in parallel, in accordance with various embodiments. Namely, in this embodiment, the cells are connected electrically in parallel, and each cell is driven by a common voltage source. The electrolyzer system 100 includes a main high-voltage distribution device 110 configured to provide an intermediate voltage to the point-of-load voltage converter 120. For example, the high-voltage distribution device 110 can provide a voltage between 10 and 50 volts. The intermediate voltage converter 120 reduces (steps down) the voltage to a range of 1 volts and 2 volts.

The intermediate voltage converter 120 (common voltage converter) can generate a voltage between 1-2 volts and distribute that power to a plurality of electrolyzer cells 140 in parallel. Each electrolyzer cell 140 includes an electrolyte coupled to receive a solution (e.g., water) and two bipolar plates. The bipolar plates can be connected to the intermediate voltage converter 120. Each electrolyzer cell 140 outputs oxygen and hydrogen. The rate of output depends on the power received by the bipolar plates of the cell. In some cases, a higher power can generate oxygen and hydrogen at a faster rate, but this reduces durability of the system. On the other hand, a lower power can generate oxygen and hydrogen at a slower rate but increase durability of the system.

Each of the electrolyzer cells 140 are coupled electrically in parallel to each other and to the intermediate voltage converter 120. A monitor control circuit 130 (e.g., a local monitor circuit) is associated with (and implemented by) each cell. The monitor control circuit 130 collects parameters of the respective cells 140 on an individual basis. For example, the monitor control circuit 130 associated with a first cell 140 implements an ADC to measure voltages across various cell components to collect any one or combination of parameters, including voltage across one or more of the plurality of electrolyzer cells, electro impedance spectroscopy (EIS), current, temperature, and gas or fluid flow. In some cases, the monitor control circuit 130 includes a processor that implements a model for the respective cell that predicts or determines performance of the cell and/or predicts or determines a failure of the cell. The monitor control circuit 130 can disable the associated cell in response to determining that the current parameters are indicative and associated with an upcoming failure of the cell.

For example, a machine learning model can be trained based on training data to predict performance and/or failure of a given cell. This trained machine learning model can then be implemented by each monitor control circuit 130 to operate on and analyze real-time parameters measured and collected from the respective cell 140. As an example, the machine learning model may be a neural network. The machine learning model is trained to establish a relationship between a plurality of operating parameters (e.g., voltage across one or more of the plurality of electrolyzer cells, EIS, current, temperature, and gas or fluid flow associated with the one or more of the plurality of electrolyzer cells) and performance or failure. For example, one training data set can indicate that for a given set of parameters, the cell failed to operate within a threshold period of time. Another training data set can indicate that for a given set of parameters, another cell outputted hydrogen and oxygen at a particularly low level and could have outputted the hydrogen and oxygen faster without failing. The machine learning model can be trained to establish a set of parameters of the machine learning model based on such data to minimize a loss function. For example, the machine learning model can predict failure or performance metrics given a set of parameters in a set of the training data. The predicted failure or performance metrics can be compared with the actual ground truth failure or performance metrics of the set of training data. A loss can be computed based on a deviation between the predicted failure or performance metrics and the ground truth failure or performance metrics. Parameters of the machine learning model can then be updated based on the computed loss. Subsequent or additional training data sets can similarly be processed to update parameters of the machine learning model until a stopping criterion is satisfied or until all of the training data is processed.

This machine learning model with such updated parameters can then be stored or implemented by the monitor control circuits 130. In this way, when the machine learning model of a given monitor control circuit 130 is presented with a new set of parameters of a given cell 140, the machine learning model can predict failure or performance metrics of the given cell 140. Based on the failure or performance metrics, voltage being delivered to the individual cell 140 can be adjusted to optimize the failure or performance metrics.

In some cases, the monitor control circuit 130 of each cell 140 communicates the collected parameters to a cloud server over the Internet, such as a control circuitry. The cloud server can then use a global model (e.g., another machine learning model) to determine or predict the performance of the overall electrolyzer system 100 and can vary the voltage or power delivered to the system 100 or cell 140 by the high-voltage distribution device 110 and/or the intermediate voltage converter 120.

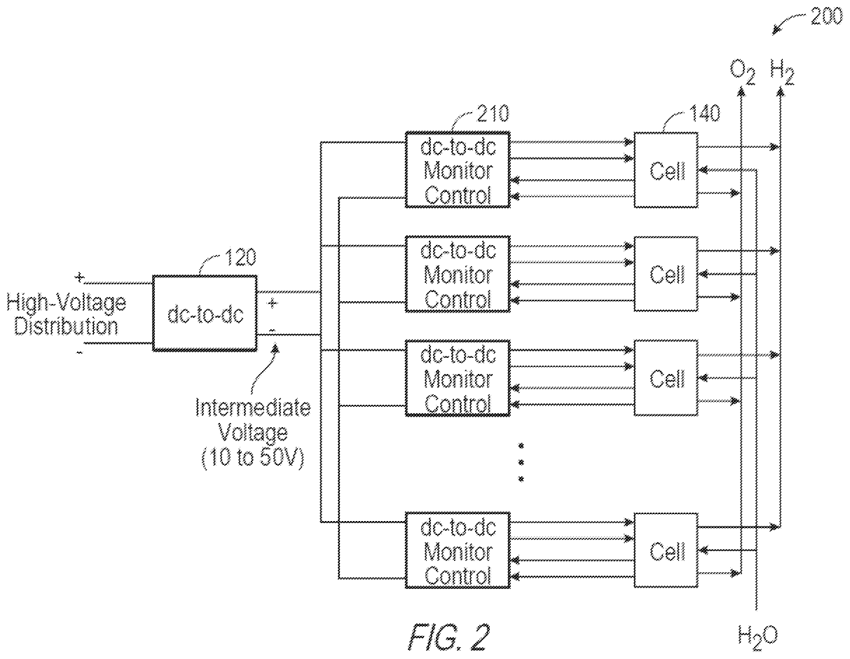

FIG. 2 is a block diagram of an example of an electrolyzer system 200, in accordance with various embodiments. The operation of electrolyzer system 200 is similar to that of electrolyzer system 100. Instead of delivering the same power and voltage to all of the electrolyzer cells 140 in parallel, each electrolyzer cell 140 includes an independent power supply and monitor control circuit 210. Specifically, the intermediate voltage converter 120 provides a voltage between 10 and 50 volts to each of the independent power supply and monitor control circuits 210 in parallel. The independent power supply and monitor control circuit 210 then converts the voltage of 10 and 50 volts to an individual supply voltage between 1 and 2 volts for the given cell. In this way, one of the cells 140 can receive and operate at a first voltage (e.g., 1 volts) while a second of the cells 140 can receive and operate at a different second voltage (e.g., 2 volts).

According to this configuration, when the monitor control circuit 210 of a given cell 140 predicts, based on measured parameters of the given cell 140, that the given cell 140 is being operated under conditions associated with an upcoming failure, the independent power supply and monitor control circuit 210 of the cell 140 can reduce the power and voltage being delivered to the corresponding cell 140 to increase the durability and lifetime of the cell or to temporarily disable operation of the cell 140. At the same time, when a given cell 140 is predicted by the associated monitor control circuit 210 to have parameters that indicate or are associated with a low performance, the independent power supply and monitor control circuit 210 of the cell 140 can increase the power and voltage being delivered to the corresponding cell 140 to increase the performance without reducing the durability and lifetime of the cell 140.

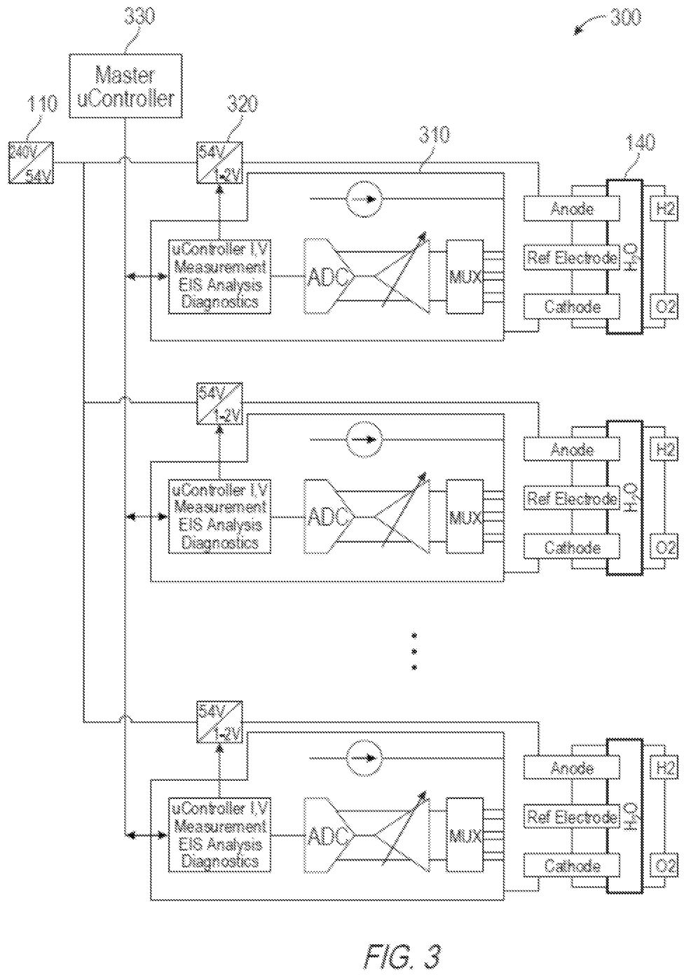

FIG. 3 is a block diagram of an example of an electrolyzer system 300, in accordance with various embodiments. Electrolyzer system 300 operates in a similar manner as electrolyzer system 200. As shown, each cell 140 is associated with a monitor circuit 310 and receives power from an individual power supply 320. Specifically, the individual power supplies 320 correspond to the individual power supplies of the monitor circuit 210 discussed in connection with FIG. 2. Namely, the individual power supplies 320 receive a voltage of between 10 and 50 volts that has been reduced from the 240 voltage generated by the high-voltage distribution device 110. The individual power supplies 320 convert the voltage of between 10 and 50 volts to an individual supply voltage between 1 and 2 volts for the given cell 140. This voltage is then applied to the anode of the cell 140.

The monitor circuit 310 associated with each respective cell 140 monitors parameters of the corresponding cell 140 and communicates such parameters to control circuitry 330, such as over the Internet. In one example, the monitor circuit 310 includes an ADC for generating the one or more parameters. The ADC can use a multiplexer to selectively measure voltages, currents, and temperature at various locations in the cell to generate the one or more parameters. In one example, the monitor circuit 310 can generate a local model for the associated cell based on the parameters of the cell it monitors. For example, the monitor circuit 310 can implement a machine learning model to analyze the one or more parameters to predict failure or performance of the cell and to thereby adjust the operating conditions of the cell 140 (e.g., increase the voltage generated by the individual power supply 320, decrease the voltage generated by the individual power supply 320, or temporarily disable the cell 140).

In some cases, the monitor circuit 310 provides the monitored and measured parameters to a remote control circuitry 330 (e.g., a central monitor circuit) that generates a model for the overall electrolyzer system 300. The model generated by the remote control circuitry 330 predicts or estimates performance, durability, and potential failure of the system 300 as a whole. The control circuitry 330 can control individual ones of the power supplies 320 to change the voltage and power being delivered to a given one of the cells 140 on an individual basis so that different voltage and power is delivered to the cells 140 in a way that maximizes durability and performance of the system 300.

The control circuitry 330 can use a communication protocol or interface to individually communicate with the monitor circuit 310 of each cell 140 on an individual basis (one at a time). The control circuitry 330 can also communicate an instruction to all of the monitor circuits 310 at the same time, such as to simultaneously increase power of all the cells 140 or decrease power of all the cells 140. This can be used to cause the cells 140 to generate oxygen and hydrogen faster or slower depending on the needs of the system 300.

In some embodiments, the control circuitry 330 is trained to model a performance and/or failure rate of cells 140 based on training data. For example, the control circuitry 330 may implement a machine learning model. The machine learning model is trained to establish a relationship between a plurality of operating parameters (e.g., voltage across one or more of the plurality of electrolyzer cells, EIS, current, temperature, and gas or fluid flow associated with the one or more of the plurality of electrolyzer cells) and performance or failure. For example, one training data set can indicate that for a given set of parameters, the cell failed to operate within a threshold period of time. Another training data set can indicate that for a given set of parameters, another cell outputted hydrogen and oxygen at a particularly low level and could have outputted the hydrogen and oxygen faster without failing. The machine learning model can be trained to establish a set of parameters of the machine learning model based on such data to minimize a loss function. For example, the machine learning model can predict failure or performance metrics given a set of parameters in a set of the training data. The predicted failure or performance metrics can be compared with the actual ground truth failure or performance metrics of the set of training data. A loss can be computed based on a deviation between the predicted failure or performance metrics and the ground truth failure or performance metrics. Parameters of the machine learning model can then be updated based on the computed loss. Subsequent or additional training data sets can similarly be processed to update parameters of the machine learning model until a stopping criterion is satisfied or until all of the training data is processed.

This machine learning model with such updated parameters can then be stored or implemented by the control circuitry 330 and/or by the individual monitor circuits 310. In this way, when the machine learning model is presented with a new set of parameters of a given cell 140 or a collection of cells 140, the machine learning model can predict failure or performance metrics of the given cell 140 or the collection of cells 140. Based on the failure or performance metrics, voltage being delivered to the overall system and/or to individual cells 140 can be adjusted to optimize the failure or performance metrics.

Each individual cell can be locally controlled by the monitor circuit 310 that implements a local version of the machine learning model. Namely, when the monitor circuit 310 measures a set of parameters using an ADC for a first cell, the monitor circuit 310 applies the measured parameters to the local machine learning model. The local machine learning model can provide an individual assessment of the performance and failure of the associated first cell. Based on the individual assessment generated by the machine learning model, the monitor circuit 310 associated with the first cell can increase the voltage applied to the cell, decrease the voltage applied to the cell, turn OFF the cell for a period of time (which may be indicated or estimated by the machine learning model), or generate an alert to a system operator.

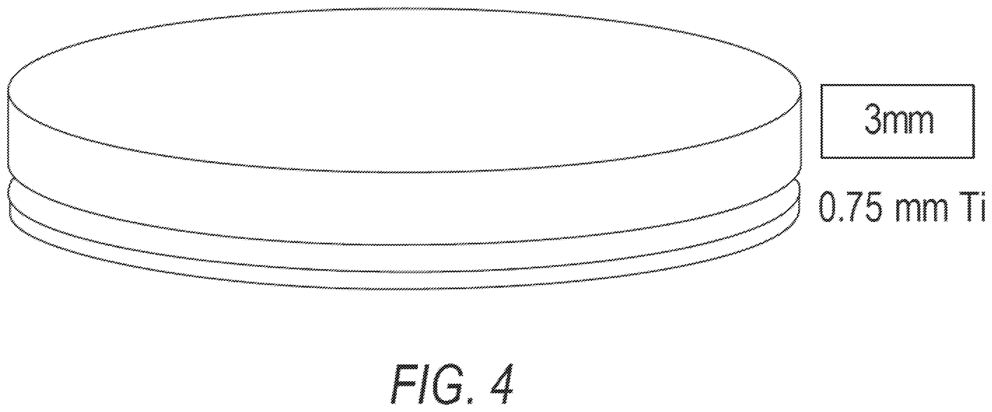

FIG. 4 is a block diagram of an example of a bipolar plate (without the flow channels shown), in accordance with various embodiments. The electrolyzer system discussed in FIG. 4 above can implement the cells in a stack structure. In such a stack structure, the flow of current is vertical through the bipolar plates. According to some embodiments, the bipolar plates of each cell are configured such that voltage can be driven from a side of the bipolar plates. The bipolar plate shown in FIG. 4 is designed to enable voltage to be driven from a side of the bipolar plate.

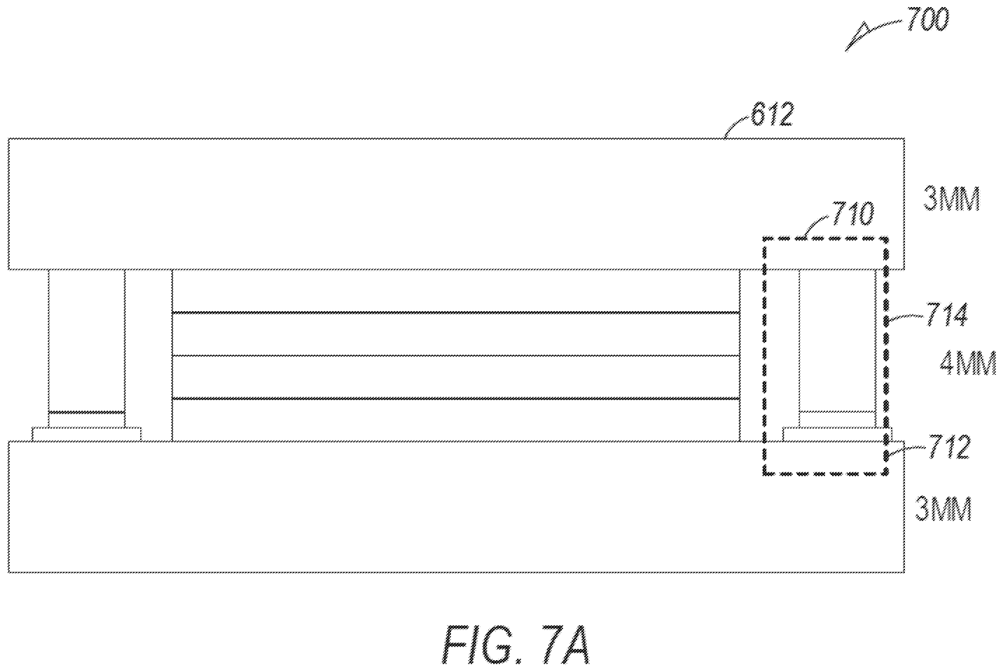

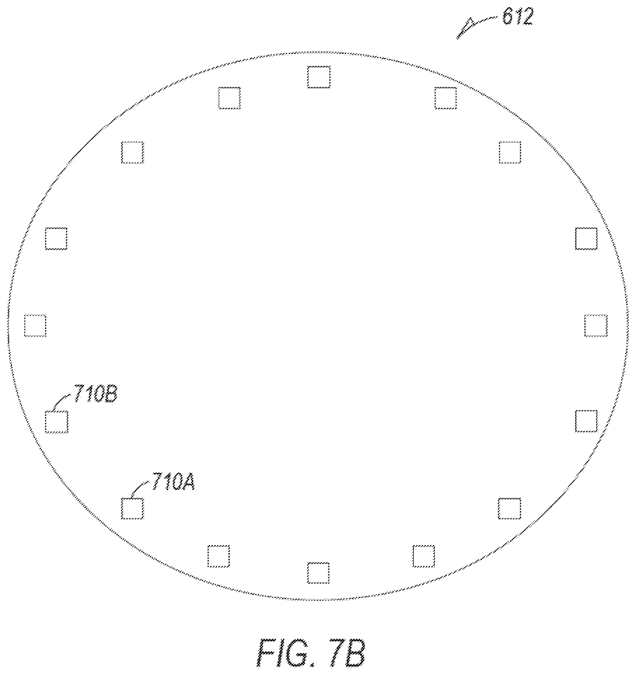

Specifically, the bipolar plate can be made up of a high-conductivity material, such as aluminum, in addition to titanium. A low-resistivity metal, such as aluminum, for example, has 15 times the conductivity of titanium (a non-reactive metal) so it can be very thin. As explained below in connection with FIGS. 7A and 7B, if the connection is made along the perimeter of the bipolar plate to enable the voltage to be driven from a side of the bipolar plate, the aluminum portion of the bipolar plate can be 3 mm thick (represented by the top cylinder in FIG. 4). Aluminum is also much less expensive than titanium. Because these commodities are sold by weight, and because aluminum has 1/1.7 times the density of titanium and 1/2.8 times the price per weight of titanium, using aluminum for the bipolar plate reduces cost of constructing the electrolyzer system. This results in higher conductivity, for approximately 1/70^{th} of the cost of titanium for the same resistance in the bipolar plate.

In some embodiments, to prevent the aluminum from reacting with the water or other elements in the electrolyzer system (which reduces reliability), the aluminum portion of the bipolar plate can be plated with titanium. Alternatively, or in addition, the aluminum portion of the bipolar plate could be sandwiched between thin titanium plates. In such cases, vias can be used to connect the two titanium plates that sandwich the aluminum. The vias can be either titanium plated or protected with some other material. For example, the bipolar plate can be constructed such that a first portion includes a titanium plate having a relatively small thickness. A second portion can include a relatively thick aluminum portion that is placed on top of the first portion. A third portion of the bipolar plate can include another titanium plate having a relatively small thickness. Namely, the second portion can be thicker than the first and third portions. A via or other electrical connection that is plated with titanium can be formed between the first and third plates. Alternatively, or in addition, a less reactive, highly conductive material (metal) can be used in place of aluminum to form the bipolar plate.

In some cases, some of the bipolar plates for a first portion of the cells of the electrolyzer can be formed according to a first manner (e.g., in which an aluminum portion of the bipolar plate is plated with titanium). A remaining portion of the bipolar plates of a second portion of the cells of the electrolyzer can be formed according to a second manner (e.g., an aluminum portion of the bipolar plate being sandwiched between thin titanium plates with connecting vias).

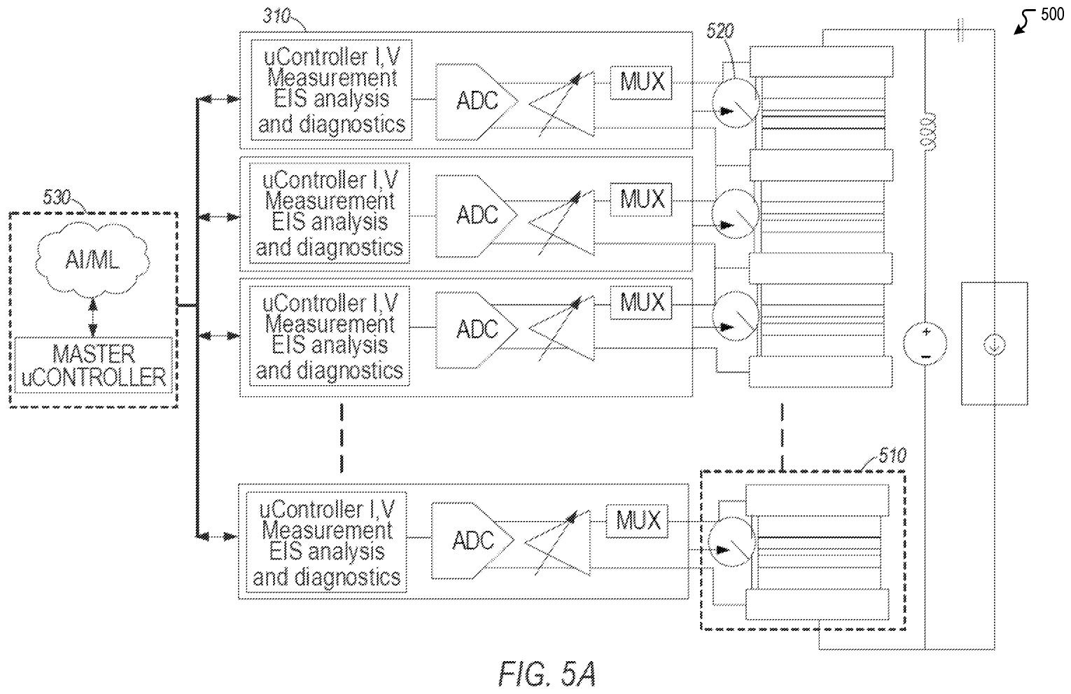

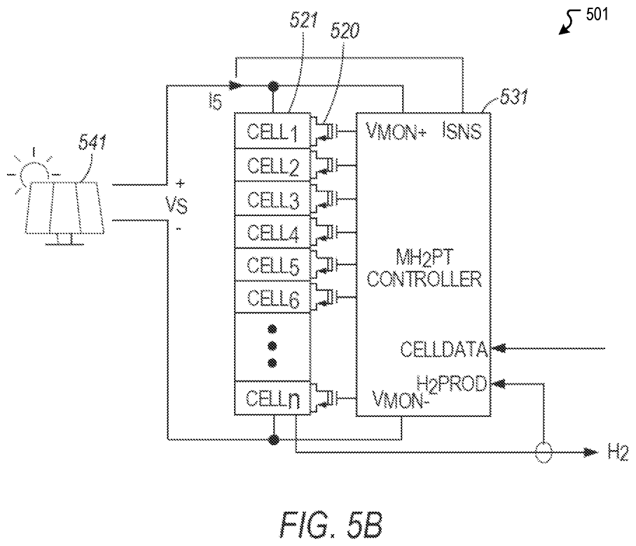

The bipolar plates discussed in connection with FIGS. 5-8 below can be formed in the same manner as discussed in connection with FIG. 4.

An alternative to providing a unique power supply to each cell, as discussed in the parallel configuration of the cells in FIGS. 1-3, the cells can be electrically connected in series and include or be associated with bypass circuitry, as shown in FIG. 5A and FIG. 5B. Specifically, FIG. 5A is a block diagram of an example of an electrolyzer system 500 including series connected electrolyzer cells 510, in accordance with various embodiments.

According to the embodiment shown in FIG. 5A, characteristics of each cell 510 can be monitored by monitor circuit 310 in a similar manner as discussed above in connection with FIGS. 1-3. Specifically, each cell 510 can be associated with a given monitor circuit 310, which controls the bypass circuitry of a given cell 510 to electrically remove completely or partially the given cell 510 from the series connection. The electrolyzer system 500 can also include a centralized controller 530, which can receive data from each of the monitor circuits 310 associated with each cell 510. As discussed above, the centralized controller 530 and/or the individual monitor circuits 310 can together or individually implement a machine learning model that predicts cell/electrolyzer behavior and likelihood of failure. The parameters being monitored by the centralized controller 530 and/or the individual monitor circuits 310 could include the cell 510 voltage at a variety of points on the bipolar plate, the temperature, and plant-wide parameters such as water and gas flow, among others discussed above. These parameters can be used to create the machine learning model of the state-of-health of each cell 510 and/or the electrolyzer system 500. The parameters may come from just the system 500 being monitored or from many electrolyzer systems 500 connected via the Internet, as discussed above.

The machine learning model can be used to predict failures so that a cell that is about to fail can be bypassed (temporarily or permanently) before it fails. This is valuable because at least one failure mode (pin holes in the membrane which allows hydrogen and oxygen to mix) would bring down the entire stack even if the cell was bypassed.

Specifically, the monitor circuit 310 associated with each respective cell 510 monitors parameters of the corresponding cell 510 and communicates such parameters to the centralized controller 530, such as over the Internet. In one example, the monitor circuit 310 includes an ADC for generating the one or more parameters. The ADC can use a multiplexer to selectively measure voltages, currents, and temperature at various locations in the cell 510 to generate the one or more parameters. In one example, the monitor circuit 310 can generate a local model for the associated cell 510 based on the parameters of the cell 510 it monitors. For example, the monitor circuit 310 can implement a machine learning model to analyze the one or more parameters to predict failure or performance of the cell 510 and to thereby adjust the operating conditions of the cell 510 (e.g., completely or partially bypass the cell 510 using its respective bypass circuitry 520).

In some cases, the monitor circuit 310 provides the monitored and measured parameters to the centralized controller 530 (e.g., a central monitor circuit) that generates a model for the overall electrolyzer system 500. The model generated by the centralized control circuitry 530 predicts or estimates performance, durability, and potential failure of the electrolyzer system 500 as a whole. The centralized controller 530 can control individual ones of the bypass circuitries 520 to selectively bypass one or more sets of cells 510 from the series connection of cells 510 in a way that maximizes durability and performance of the electrolyzer system 500.

The centralized controller 530 can use a communication protocol or interface to individually communicate with the monitor circuit 310 of each cell 510 on an individual basis (one at a time). The control circuitry 530 can also communicate an instruction to all of the monitor circuits 310 at the same time.

In some embodiments, the centralized controller 530 is trained to model a performance and/or failure rate of cells 510 based on training data. For example, the centralized controller 530 may implement a machine learning model. The machine learning model is trained to establish a relationship between a plurality of operating parameters (e.g., voltage across one or more of the plurality of electrolyzer cells, EIS, current, temperature, and gas or fluid flow associated with the one or more of the plurality of electrolyzer cells 510) and performance or failure. For example, one training data set can indicate that for a given set of parameters, the cell failed to operate within a threshold period of time. Another training data set can indicate that for a given set of parameters, another cell outputted hydrogen and oxygen at a particularly low level and could have outputted the hydrogen and oxygen faster without failing. The machine learning model can be trained to establish a set of parameters of the machine learning model based on such data to minimize a loss function. For example, the machine learning model can predict failure or performance metrics given a set of parameters in a set of the training data. The predicted failure or performance metrics can be compared with the actual ground truth failure or performance metrics of the set of training data. A loss can be computed based on a deviation between the predicted failure or performance metrics and the ground truth failure or performance metrics. Parameters of the machine learning model can then be updated based on the computed loss. Subsequent or additional training data sets can similarly be processed to update parameters of the machine learning model until a stopping criterion is satisfied or until all of the training data is processed.

This machine learning model with such updated parameters can then be stored or implemented by the centralized controller 530 and/or by the individual monitor circuits 310. In this way, when the machine learning model is presented with a new set of parameters of a given cell 510 or a collection of cells 510, the machine learning model can predict failure or performance metrics of the given cell 510 or the collection of cells 510. Based on the failure or performance metrics, bypass circuitries 520 of respective cells can be activated to bypass or completely or partially remove the associated cell 510 from the electrical series connection of cells 510.

Each individual cell can be locally controlled by the monitor circuit 310 that implements a local version of the machine learning model. Namely, when the monitor circuit 310 measures a set of parameters using an ADC for a first cell, the monitor circuit 310 applies the measured parameters to the local machine learning model. The local machine learning model can provide an individual assessment of the performance and failure of the associated first cell. Based on the individual assessment generated by the machine learning model, the monitor circuit 310 associated with the first cell 510 can activate the bypass circuitry 520 of the first cell 510 to electrically completely or partially remove the cell 510 from the electrical series connection of cells 510, such as for a period of time (which may be indicated or estimated by the machine learning model), or generate an alert to a system operator.

In some cases, for bypassing a given cell 510, the current can be shunted across the cell 510 using respective bypass circuitry 520 of the cell 510. The bypass circuitry 520 forms an electrical connection directly between the two bipolar plates of a given cell 510 when the bypass circuitry is activated. Namely, to bypass or remove the cell 510 from an electrical series connection with other cells 510, one or more switches included in the bypass circuitry 520 are closed to directly connect the two bipolar plates of the cell 510. To reconnect the cell to the series connected cells 510, the one or more switches of the bypass circuitry 520 are opened to cause current to flow through other components of the cell 510 between the two bipolar plates. The closing of the one or more switches bypasses the other components of the cell 510, which effectively electrically removes the cell from the series connection of cells 510.

In some cases, the bipolar plate's “horizontal” resistance is configured to be small enough for there to be a substantially uniform voltage across the bipolar plate. In some examples, it may not be necessary for all of the current to be shunted. Namely, if a cell is beginning to fail, a portion of the current could be shunted to reduce the voltage across the cell and slow its aging. To shunt only a portion of the current, a plurality of switches can be disposed around the bipolar plate and only some of the plurality of switches may be closed. This causes some of the current to be shunted and directly flow from one bipolar plate to another while other portions of the current flow through other components of the cell between the bipolar plates. Namely, the switches can be controlled such that they behave as variable resistors and thus shunt some of the current. This allows each cell to have a unique voltage, as discussed in FIGS. 1-3, with each cell having a unique power supply.

In some cases, the switches are implemented as transistors that implement a variable resistor. This allows the switch to be in a state which is neither opened or closed but something in between to allow the amount of current that is shunted to be variable. When the switch is implemented in a variable resistance mode, the switch can be used to generate an EIS stimulus. In this case, the switch's (or variable resistor's) control terminal can be modulated to shunt some portion of the current at a desired frequency.

FIG. 5B is a block diagram of an example of an electrolyzer system 501 including series connected electrolyzer cells coupled to a solar PV, in accordance with various embodiments. While the disclosed embodiments are discussed in connection with a solar PV, any other suitable renewable energy source can be provided in addition to or in place of the solar PV. Namely, rather than providing power to the electrolyzer cells of the electrolyzer from a carbon-based fossil fuel power source, power to the electrolyzer system 501 is provided from a renewable energy source, such as a solar PV.

Providing power to an electrolyzer from a renewable energy source is not trivial. Renewable energy sources typically provide power that varies over time, such as based on wind changes or available solar energy. Because the power varies over time, the efficiency of hydrogen production of the electrolyzer is difficult to predict and control. Certain systems use available AC-DC rectifiers and DC-AC inverters (or a DC-DC converter) in an attempt to balance and make the variable power that is provided to the electrolyzer more constant. However, using such additional components not only increases the cost of such systems but also reduces the overall efficiency of hydrogen production.

The electrolyzer system 501 provides a more optimized solution to powering an electrolyzer with a renewable energy source that employs a method for controlling an electrolyzer stack with bypass circuitry coupled to the cells. The disclosed approach leads to lower cost and other advantages, such as increased hydrogen production efficiency. The goal of the power system shown in FIG. 5B is to extract the maximum power from the solar PV array (the renewable energy source) and transfer that power to the electrolyzer while keeping the electrolyzer operating in a safe and efficient manner. According to the disclosed approach, the electrolyzer can be power by a renewable energy source without the need for a power conversion stage (e.g., AC-DC rectifiers and DC-AC inverters or DC-DC converters).

The electrolyzer system 501 includes electrolyzer 521 with bypass circuitry 520 that enables bypassing individual ones of the cells of the electrolyzer 521. The electrolyzer 521 includes some or all of the components of cell 510 (FIG. 5A). As an example, the electrolyzer 521 includes a plurality of electrolyzer cells, each of the electrolyzer cells comprising a plurality of bipolar plates coupled to form an electrical series connection through the plurality of electrolyzer cells. The bypass circuitry 520 is configured to electrically remove individual cells or groups of the plurality of electrolyzer cells of the electrolyzer 521 from the electrical series connection while maintaining flow of current through remaining electrolyzer cells.

The electrolyzer 521 is coupled to receive power from a renewable energy source 541 (e.g., a solar PV array). A controller 531 monitors the voltage and current supplied by the renewable energy source 541 and calculates the power generated by the renewable energy source 541. The controller 531 may include some or all of the components of monitor circuit 310 and/or centralized controller 530. The controller 531 may receive or derive information about the hydrogen production rate of the electrolyzer 521 and information about the state-of-health (SOH) of individual cells of the electrolyzer 521 (e.g., using machine learning techniques discussed above). With the information collected, the controller 531 activates/deactivates switch elements of the bypass circuitry 520 to selectively electrically remove individual cells or groups of cells of the electrolyzer 521 from the electrical series connection. The algorithm for activating the switch elements of the bypass circuitry 520 can be optimized for maximizing hydrogen production, extending the useful life of the electrolyzer, and assuring safe operation.

In one example, maximum power is extracted from renewable energy source 541 when the load connected to the renewable energy source 541 draws power at a current/voltage operating point referred to as the maximum power point. A series of I-V curves of a renewable energy source 541, along with the maximum power points can be determined.

The series of I-V curves shows the power that can be delivered by the renewable energy source 541 along the possible current and voltage operating points as a function of the renewable energy, such as solar irradiance (G) impacting a solar module.

According to the disclosed embodiments, the controller 531 adjusts a size of the electrolyzer to sweep a curve that maximizes use of the maximum power point of the renewable energy source 541. In some cases, when all cells are bypassed, the electrolyzer stack has an effective length of 0 cells and looks like a short circuit. The controller 531 can set the effective length to 0 cells to provide a short circuit when the power output by the renewable energy source 541 is less than a threshold. As the power output by the renewable energy source 541 starts to exceed the threshold, the controller 531 adds more cells to the stack to increase the length and size of the electrolyzer stack to follow a curve towards the highest impedance load, which corresponds to the maximum stack length where none of the cells are bypassed. After the power output by the renewable energy source 541 reaches the maximum power point and begins to drop, the controller 531 again adjusts the size to reduce the size of the electrolyzer stack. In this way, the controller 531 dynamically changes the number of cells of an electrolyzer that are bypassed or active, to vary a load presented to the to the renewable energy source 541 in a way that is very close to the maximum power point of the renewable energy source 541.

In some cases, the effective stack length can be adjusted to maximize power extracted from the renewable energy source 541. In some cases, the effective stack length can be adjusted to maximize hydrogen production by the electrolyzer 521. The efficiency of the electrolyzer 521 varies with current. As such, maximizing power (P) means maximizing, P=I*V, while maximizing hydrogen production means maximizing (H), H=η(I)*I*V=I*V_{TH}, where H is hydrogen production rate η(I) is the electrolyzer stack efficiency as a function of current I, I is the electrolyzer stack current, V is the electrolyzer stack voltage, and V_{TH} is the thermoneutral voltage.

In one example, the controller 531 controls the bypass circuitry 520 to vary the length/size of the electrolyzer 521 by measuring initially a peak hydrogen production point. The controller 531 measures the current rate of hydrogen production at a given time, such as by measuring the flow rate of the hydrogen produced, or indirectly by measuring the current and voltage consumed by the electrolyzer 521 and calculating the rate of hydrogen production in accordance with H=η(I)*I*V. The controller 531 can then compute a difference between the current rate of hydrogen production and the hydrogen production rate at a previous time when the stack size of the electrolyzer 521 was changed. Namely, the controller 531 can store the rate of hydrogen product at a particular time when the controller 531 increases or decreases the size of the electrolyzer 521 by bypassing or not bypassing individual cells or groups of cells of the electrolyzer 521 using the bypass circuitry 520. The controller 531 can also store the value of the current output by the renewable energy source 541 and received by the electrolyzer 521 at the time the controller 531 increases or decreases the size of the electrolyzer 521.

At some predetermined or period point in the future, the controller 531 measures the current hydrogen production rate and computes a difference between the current hydrogen production rate and the previously stored hydrogen production rate. The controller 531 can compare the difference between the current hydrogen production rate and the previously stored hydrogen production rate to a first threshold, such as −ε₁. The controller 531 can also determine the value of the current presently being output by the renewable energy source 541 and received by the electrolyzer 521 and compare that value of the current to the previously stored value of the current when the last time the electrolyzer 521 size was changed. The controller 531 compares the difference between the two values of the current to a second threshold, such as ε₂. The controller 531 can increase the effective stack size of the electrolyzer 521 by deactivating one or more switches of the bypass circuitry 520 (so as to not shunt the current from one bipolar plate to another bipolar plate of corresponding cells) in response to determining that the difference between the current hydrogen production rate and the previously stored hydrogen production rate is less than the first threshold and in response to determining that the difference between the two values of the current is greater than the second threshold. This may be indicative of a situation in which hydrogen production is decreasing while current provided by the renewable energy source 541 is increasing. In this situation, the controller 531 increases the size of the electrolyzer 521 to increase production of hydrogen.

The controller 531 can decrease the effective stack size of the electrolyzer 521 by activating one or more switches of the bypass circuitry 520 (so as to shunt the current from one bipolar plate to another bipolar plate of corresponding cells) in response to determining that the difference between the current hydrogen production rate and the previously stored hydrogen production rate is less than the first threshold and in response to determining that the difference between the two values of the current is less than the second threshold or less than a negative of the second threshold (e.g., a third threshold). This may be indicative of a situation in which hydrogen production is decreasing while current provided by the renewable energy source 541 is also decreasing. In this situation, the controller 531 decreases the size of the electrolyzer 521 to attempt to increase efficiency of production of hydrogen by consuming the less available current using a fewer quantity of cells.

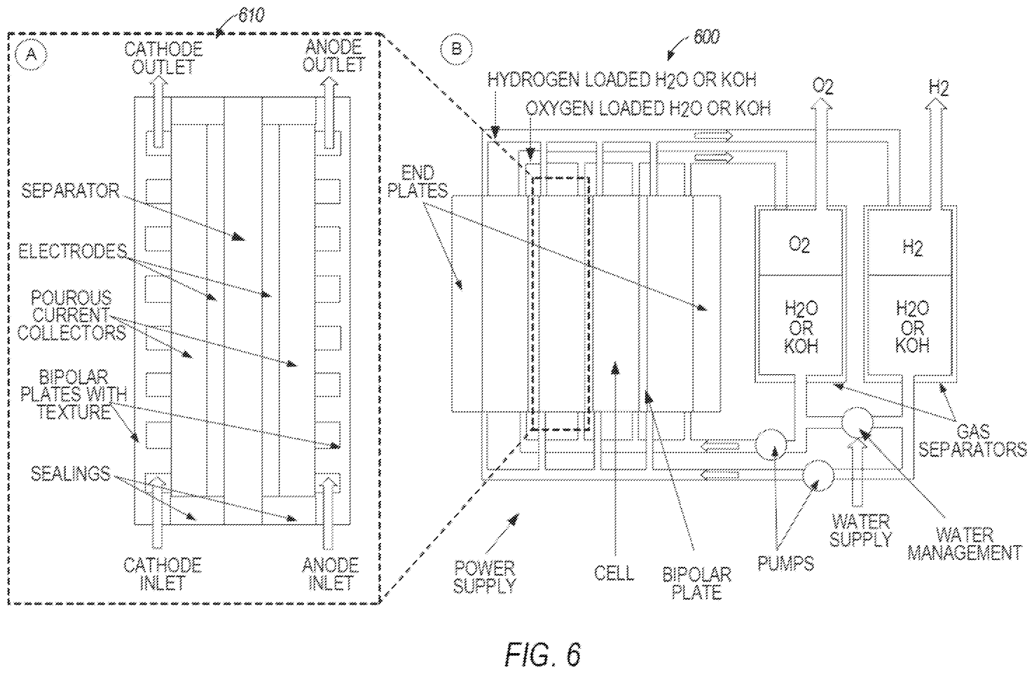

In some embodiments, each cell 510 is implemented as a stack of elements that are included between two bipolar plates. An example of a layout of elements of a given cell 510 are shown in FIG. 6. Specifically, as shown in FIG. 6, a set of series connected cells can be included in an electrolyzer 600. The electrolyzer 600 includes similar components as the electrolyzer system 500. The electrolyzer 600 includes a cell 610 that includes a pair of bipolar plates. The bipolar plate of one cell 610 can be shared with an adjacent cell (not shown in FIG. 6). The cell 610 includes elements on an interior portion, such as an anode inlet, a cathode inlet, a cathode outlet, an anode outlet, a sealings portion, porous current collectors, electrodes, and a separator.

The bypass circuitry 520 can include a switch coupled between the bipolar plates 612 of a given cell 610. In such implementations, the bypass circuitry 520 may be implemented outside or external to the components of the given cell 610. The bypass circuitry 520 is configured to bypass the elements of the given cell 610 when the switch is closed. This causes the given cell 610 to be electrically removed from the series of cells 610 because current is shunted from one bipolar plate to another of the cell 610. Several bypass circuitries 520 can be associated, each with respect to a given one of the many cells 610 of the electrolyzer 600. Any given one of the cells 610 can be electrically removed from the series connection of cells 610 by activating or closing the switch of the bypass circuitry 520 associated with the particular cell 610. While the bipolar plates 612 are shown as being circular, the bipolar plates can be of any suitable shape, such as rectangular or octangular in shape.

In some implementations, the bypass circuitry 520 can be integrated within each of the cells 610 to avoid implementing or running physical wires around the cells 610. In such cases, the bipolar plates 612 and the sealing portion of the cell 510 are extended to make room for the bypass circuitry 520. FIG. 7A shows a cross-sectional view 700 of the stack of elements of the given cell 610 in such an implementation. As shown, bypass circuitry 710 is placed between the bipolar plates 612 of the given cell 610. The bypass circuitry 710 is disposed around the perimeter of the cell 610 to avoid interfering with water and gas flow among the elements of the cell 610. The bypass circuitry 710 can include a printed circuit board (PCB) 712, system-on-chip, integrated circuit, or some other device on which a processing element is integrated. The PCB 712 (processing element) is coupled to wiring, such as copper 714 or other conductive metal. The PCB 712 (processing element) controls whether current flows from one bipolar plate 612 to another through the copper 714. Namely, when the PCB 712 (processing element) closes a switch, the current flows from one bipolar plate 612 to another through the copper 714 and avoids flowing through other elements of the cell 610.

In some cases, multiple bypass circuitries 710 can be disposed around the perimeter of the cell 610. This causes the current flowing between the bipolar plates to be divided among multiple bypass circuitries 710 when the switches of the bypass circuitries 710 are closed. FIG. 7B shows an implementation of the bipolar plates 612 that include multiple bypass circuitries 710A and 710B disposed around the perimeter of the cell 610. In some cases, only a portion of the current may need to be shunted to reduce the overall current flowing through the cell 610. In such cases, a first set of the bypass circuitries 710A can be configured to allow a certain amount of current to flow between the bipolar plates 612 while a remaining amount of current continues to flow through other elements of the cell 610. Specifically, there may be a given amount of current that is received by a given bipolar plate 612, and each bypass circuitry 710A and 710B is only configured to allow flow of a maximum portion of current that is less than the total given amount of current that is received. In such cases, the total given amount of current is divided such that an amount equal to the maximum portion accumulated across the subset of bypass circuitries 710A that are enabled (e.g., in which the switches are closed) flows directly between the bipolar plates 612 while the remaining portion of the given amount of current flows through other elements of the cell 610. In this way, the cell 610 can be partially removed from the series connection of cells 610. As an example, the total given amount of current can be 3 mA and only half of the bypass circuitries 710A and 710B are activated, with each being configured to allow 0.5 mA of current to flow through. In such cases, the 3 mA of total current is divided such that 2 mA accumulated across the subset of bypass circuitries 710A (e.g., half of the bypass circuitries 710A multiplied by 0.5 mA) flows directly between the bipolar plates 612 while the remaining 1 mA portion of the given amount of current flows through other elements of the cell 610.

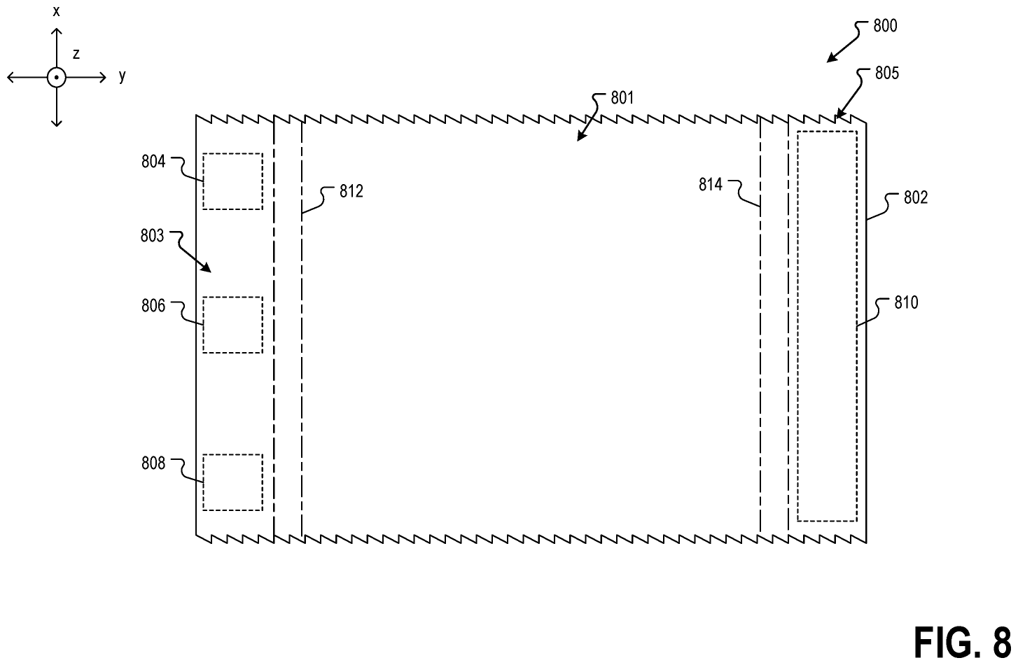

FIG. 8 is a diagram showing one example of a view of a portion 800 of a bipolar plate 802 comprising example bypass circuitry including example switches 804, 806, 808. The bipolar plate 802 may extend beyond the broken edges of the illustrated portion 800. In some examples, the bipolar plate 802 may be square or rectangular. In the example of FIG. 8, and as used herein, positions and directions are indicated with respect to a three-dimensional coordinate system including an X axis, a Y axis, and a Z axis. For directions that are not perpendicular to the page, the positive directions on the respective axes are indicated by the position of the letters. For example, in FIG. 8, the letter X indicates the positive X axis and the Y indicates the positive Y axis. In the example of FIG. 8, the Z axis is perpendicular to the paid and the positive Z axis extends out of the page.

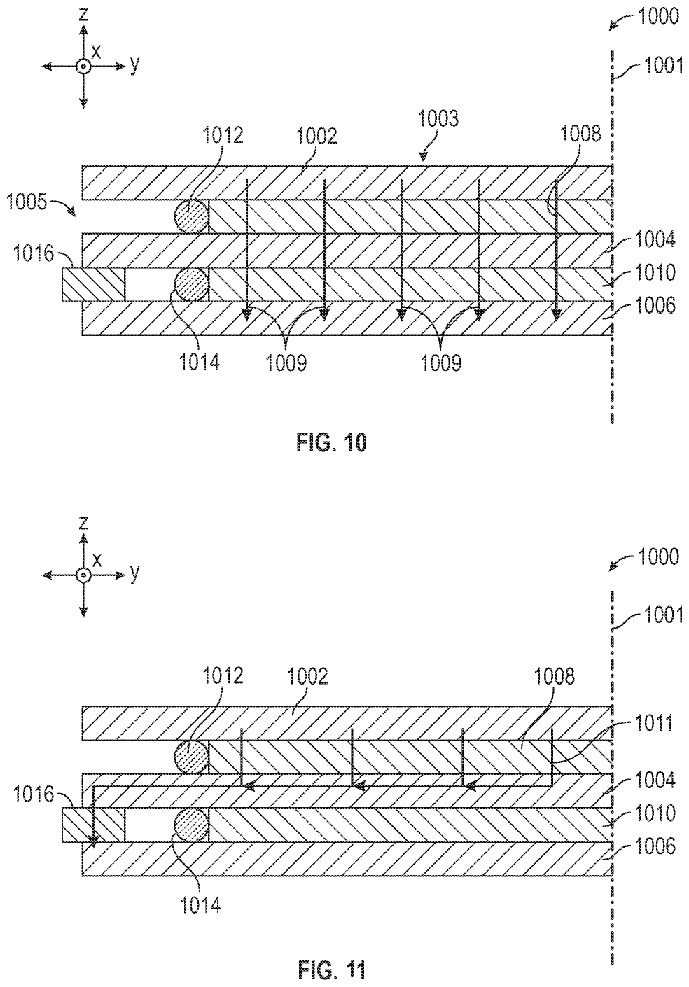

The bipolar plate 802 may make up part of one or more electrolyzer cells. For example, the bipolar plate 802 may make up an electrolyzer cell in conjunction with a second bipolar plate (not shown) that is positioned below the bipolar plate 802 in the direction of the negative Z axis. For example, the bipolar plate 802, in whole or in part, may act as one electrode of the electrolyzer cell and the second electrode may act as the second electrode of the electrolyzer cell. In some examples, the bipolar plate 802 may also make up part of a second electrolyzer cell in conjunction with an additional bipolar plate (not shown) that is positioned above the bipolar plate 802 in the direction of the positive Z axis. Examples of arrangements of bipolar plates implementing electrolyzer cells in such a stacked configuration are described herein, for example, with respect to FIGS. 10-11.

In the example of FIG. 8, additional components indicated by dashed lines are positioned between the bipolar plate 802 and the second bipolar plate (not shown) that is positioned below the bipolar plate 802 in the direction of the negative Z axis. Gaskets 812, 814 may delineate an interior portion 801 of the bipolar plate 802 from edges 803, 805 of the bipolar plate 802. The interior portion 801 may implement, house, and/or be in physical contact with other components of an electrolyzer cell made up of the bipolar plate 802 and the second bipolar plate. Components implemented by, housed by, or in contact with the interior portion 801 may include, for example, an anode inlet, a cathode inlet, a cathode outlet, an anode outlet, a sealings portion, porous current collectors, electrodes, a separator and/or the like. The gaskets 812, 814 may be positioned in contact with the bipolar plate 802 and the second bipolar plate to prevent electrolyte, water, gas, and other fluids from leaking from between the two bipolar plates.

In the example of FIG. 8, bypass circuitry, including example switches 804, 806, 808, is positioned between the bipolar plate 802 and the second bipolar plate at the edge 803. For example, switches 804, 806, 808 are positioned to be electrically coupled to the bipolar plate 802 and the second bipolar plate. Although three switches 804, 806, 808 are shown, any suitable number of switches may be used. Further, the spacing and/or placement of the switches at the edges 803 may vary. In some examples, switches may not be placed above or below the inlets and outlets of channels for gases or liquids.

The example of FIG. 8 also shows a cooling mechanism 810 positioned on the edge 805 opposite the edge 803. The cooling mechanism 810 may be, or include, a flow channel for water or another coolant and/or a material that is thermally dissipative and electrically insulating. Example thermally dissipative, electrically insulating materials that may be used to implement all or part of the cooling mechanism 810 include semiconductor materials such as Si3N4, Al2O3, AlN, SiC, GaAs, InP, Si, Ge, and GaP. Also, although the cooling mechanism 810 shown in FIG. 8 has a limited dimension in the direction of the X axis, it will be appreciated that a cooling mechanism may extend along the length of the bipolar plate 802 along the direction of the X axis. For example, the cooling mechanism 810 may include a flow channel or inlet for containing a flow of water, for example, as described herein. In some examples, cooling mechanism 810 may be selected based on the expected operating temperature, pressure, stresses, and/or other operating conditions of the stack.

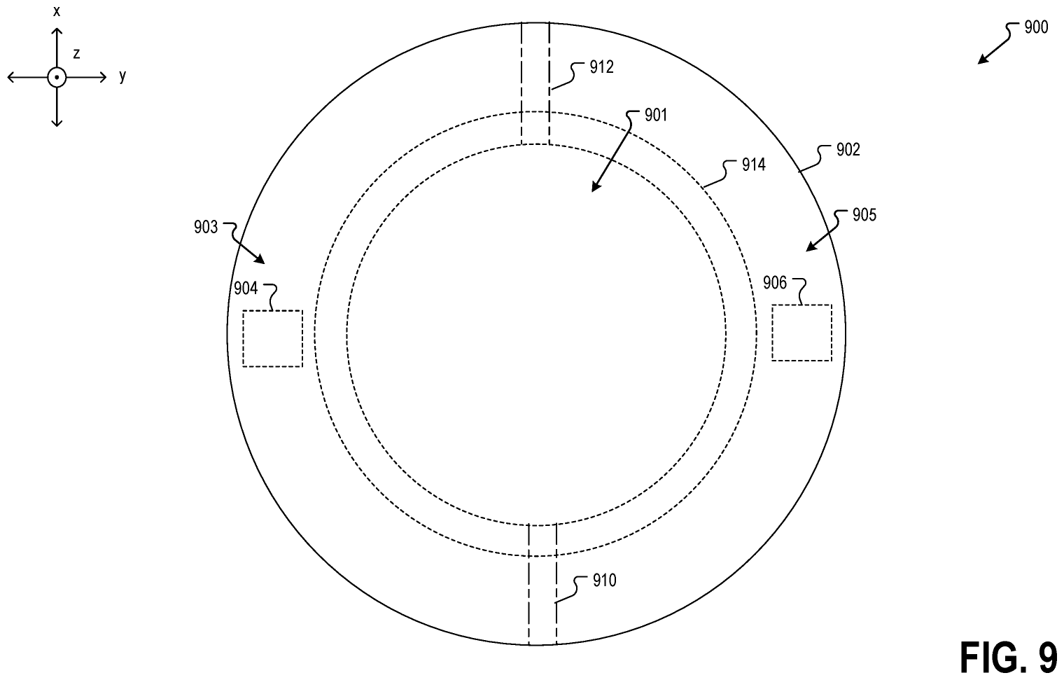

FIG. 9 is a diagram showing one example of a view of a portion 900 of a bipolar plate 902 comprising example bypass circuitry including an example switch 904. Similar to the bipolar plate 802, the bipolar plate 902 may make up one or more electrolyzer cells in conjunction with one or more other bipolar plates stacked along the Z axis. In this example, the bipolar plate 902 makes up an electrolyzer cell with a second bipolar plate (not shown) that is positioned below the bipolar plate 902 in the direction of the negative Z axis. A gasket 914 delineates an interior portion 901 of the bipolar plate 902. The interior portion 901 may implement, house, and/or be in physical contact with other components of an electrolyzer cell made up of the bipolar plate 902 and the second bipolar plate. FIG. 9 also illustrates an example inlet 910 and outlet 912. The inlet 910 may receive input materials a reaction occurring in the electrolyzer cell such as, for example, water and/or the like. The input materials may be provided through the inlet 910 to the interior portion 901. In examples where there are multiple input materials to the reaction, there may be multiple inlets (not shown). The outlet 912 may receive products of the reaction from the interior portion 901. In examples in which there are multiple products of the reaction, there may be multiple outlets 912.

FIG. 9 also illustrates edges 903, 905 positioned outside the gasket 914. In this example, the edge 903 includes bypass circuitry including a switch 904 electrically coupled to the bipolar plate 902 and the second bipolar plate. The edge 905 includes a cooling mechanism 906 that may be similar to the cooling mechanism 810. The edges 903, 905 of the bipolar plate 902 may be opposite one another. For example, the edges 903, 905 may be on different halves of the bipolar plate 902. In some examples, the edges 903, 905 are positioned on opposite sides of the inlet 910 and outlet 912. Also, in some examples, the edges 903, 905 may be opposite one another when the respective components 904, 906 are separated by a threshold angle such as, for example, 30°, 40°, 50°, 60°, 90°, 100°, 110°, 120°, 130°, 140°, 150°, 160°, 170°, 180°, and/or the like. Also, it will be appreciated that cooling mechanisms, such as the cooling mechanism 906, may extend throughout the edge 905. Also, in some examples, additional cooling mechanisms (not shown in FIG. 9) may be provided on the edge 905. Further, in some examples, cooling mechanisms and switches may be interspersed.

FIGS. 10 and 11 are diagrams showing a cross-sectional view of a portion of an electrolyzer stack 1000 comprising three bipolar plates 1002, 1004, 1006 stacked along the Z axis. The cross-sectional view of the electrolyzer stack 1000 is also along the line 1001. The bipolar plates 1002, 1004, 1006 illustrate an example stack arrangement that may be or be similar to the various bipolar plate arrangements described herein including, for example, bipolar plate 612, bipolar plate 802, bipolar plate 902, bipolar plate 1200, and/or bipolar plate 1300.

The three bipolar plates 1002, 1004, 1006 implement two electrolyzer cells. A first electrolyzer cell is implemented between the bipolar plate 1002 and the bipolar plate 1004. A second electrolyzer cell is implemented between the bipolar plate 1004 and the bipolar plate 1006. Electrolytic membranes 1008, 1010 are positioned between the respective bipolar plates 1002, 1004, 1006. Also, gaskets 1012, 1014 delineate an interior portion of the stack 1003 from an edge of the stack 1005.

In the example of FIG. 10 a switch 1016 is positioned between the bipolar plate 1004 and the bipolar plate 1006. The switch 1016 may be any suitable type of switch including, for example, a solid-state switch such as a field effect transistor (FET), a bipolar transistor, and/or the like. Also, in some examples, the switch 1016 may be a mechanical switch, for example, as described herein. The switch 1016 may be electrically coupled between the bipolar plate 1004 and the bipolar plate 1006 to selectively electrically couple bipolar plate 1004 and the bipolar plate 1006. For example, the switch 1016 may have a first state in which there is an open circuit between the bipolar plate 1004 and the bipolar plate 1006. In this state, current may flow through the electrolyzer cell as indicated by arrows 1009 in FIG. 10. The switch 1016 may also have a second state in which the bipolar plate 1004 is electrically coupled to the bipolar plate 1006. In this state, current may be shunted through the switch 1016, as indicated by arrows 1011 in FIG. 11. In the switch state indicated in FIG. 11, current may not flow through the electrolytic membrane 1010. Accordingly, the electrolyzer cell comprising bipolar plates 1004, 1006 and the electrolytic membrane 1010 may be bypassed.

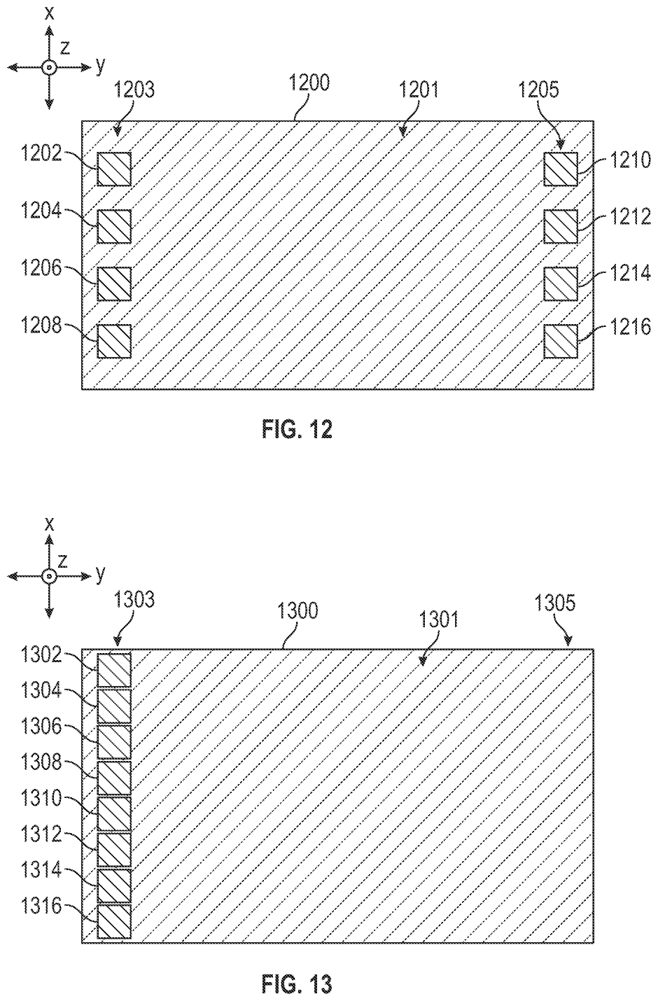

FIG. 12 is a diagram showing one example view of a bipolar plate 1200 comprising example bypass circuitry including example switches 1202, 1204, 1206, 1208, 1210, 1212, 1214, 1216. The bipolar plate 1200, in some examples, may be stacked with other bipolar plates along the Z axis to form an electrolyzer stack. For example, the bipolar plate 1200 may make up an electrolyzer cell the bipolar plate 1200 in the direction of the positive Z axis. Other components of the cell may be positioned relative to the interior portion 1201 of the bipolar plate 1200 as described herein.

Switches 1202, 1204, 1206, 1208, 1210, 1212, 1214, 1216 may be configured to selectively electrically couple the bipolar plate 1200 and the second bipolar plate, as described herein. In the example of FIG. 12, the switches 1202, 1204, 1206, 1208, 1210, 1212, 1214, 1216 are positioned on the bipolar plate 1200 at opposite edges. For example, the switches 1202, 1204, 1206, 1208 are positioned at an edge 1203 of the bipolar plate 1200 and switches 1210, 1212, 1214, 1216 are positioned at an edge 1205 of the bipolar plate 1200 that is opposite the edge 1203. For example, the interior portion 1201 may be between the edge 1203 and the edge 1205.

FIG. 13 is a diagram showing one example view of a bipolar plate 1300 comprising example bypass circuitry including example switches 1302, 1304, 1306, 1308, 1310, 1312, 1314, 1316. The bipolar plate 1300, in some examples, may be stacked with other bipolar plates along the Z axis to form an electrolyzer stack. For example, the bipolar plate 1300 may make up an electrolyzer cell the bipolar plate 1300 in the direction of the positive Z axis. Other components of the cell may be positioned relative to the interior portion 1301 of the bipolar plate 1300 as described herein. In the example of FIG. 13, the switches 1302, 1304, 1306, 1308, 1310, 1312, 1314, 1316 are positioned on an edge 1303. Also, in this example, no switches are positioned on the edge 1305.

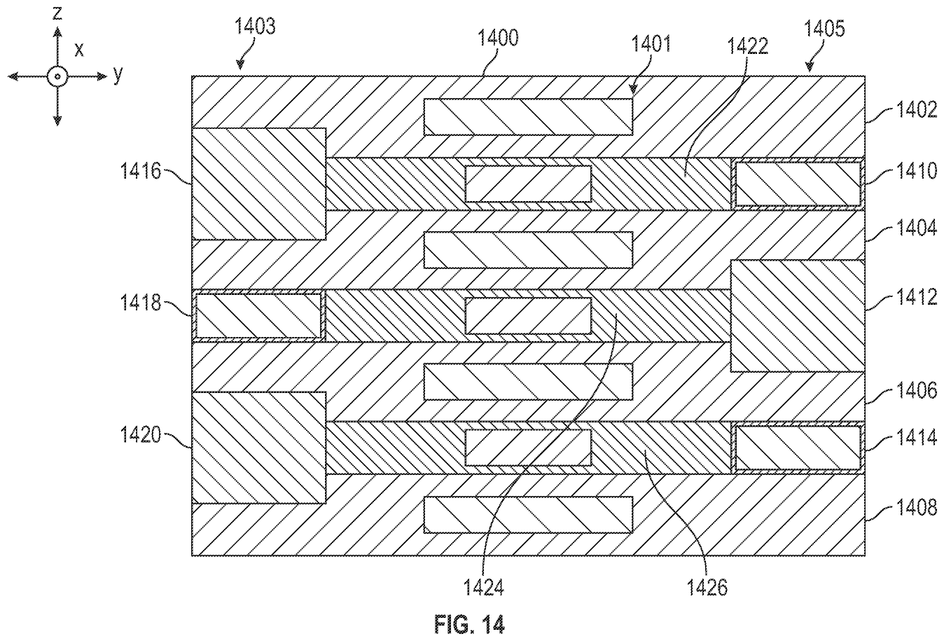

FIG. 14 is a diagram showing a cross-sectional view of a portion of an electrolyzer stack 1400 comprising four bipolar plates 1402, 1404, 1406, 1408. The bipolar plates 1402, 1404, 1406, 1408 illustrate an example stack arrangement that may be generated using any of the various bipolar plate arrangements described herein including, for example, the bipolar plate 802, the bipolar plate 902, the bipolar plate 1300, and the like.

In the example of FIG. 14, a first electrolyzer cell comprises the bipolar plate 1402, the bipolar plate 1404, and an electrolytic membrane 1422. The electrolytic membrane 1422 is positioned at an interior portion 1401 of the stack 1400 between the bipolar plates 1402, 1404. A switch 1410 between bipolar plates 1402, 1404 implements bypass circuitry for the first electrolyzer cell. A second electrolyzer cell comprises the bipolar plate 1404, the bipolar plate 1406, and an electrolytic membrane 1424. The electrolytic membrane 1424 is positioned at the interior portion 1401 of the stack 1400 between the bipolar plates 1404, 1406. A switch 1418 between bipolar plates 1404, 1406 implements bypass circuitry for the second electrolyzer cell. A third electrolyzer cell comprises the bipolar plate 1406, the bipolar plate 1408, and an electrolytic membrane 1426. The electrolytic membrane 1426 is positioned at an interior portion 1401 of the stack 1400 between the bipolar plates 1406, 1408. A switch 1414 between bipolar plates 1406, 1408 implements bypass circuitry for the third electrolyzer cell.

The example electrolyzer stack 1400 also includes cooling mechanisms 1412, 1416, 1420. The cooling mechanisms 1412, 1416, 1420 may provide cooling to the bipolar plates 1402, 1404, 1406, 1408. The cooling mechanisms 1412, 1416, 1420 may be or include any suitable type of cooling mechanism including, for example, a flow channel for water or another coolant, a material that is thermally dissipative and electrically insulating, and/or the like.

In the electrolyzer stack 1400, the switches 1410, 1414, 1418 and cooling mechanisms 1412, 1416, 1420 are placed alternately on the respective edges 1403, 1405 of the electrolyzer stack 1400. For example, along the Z axis, switches 1410, 1414, 1418 is adjacent to a cooling mechanism 1412, 1416, 1420. This arrangement may increase the space available for the cooling circuit, for example, because cooling circuits may not be adjacent to one another along the direction of the Z axis.

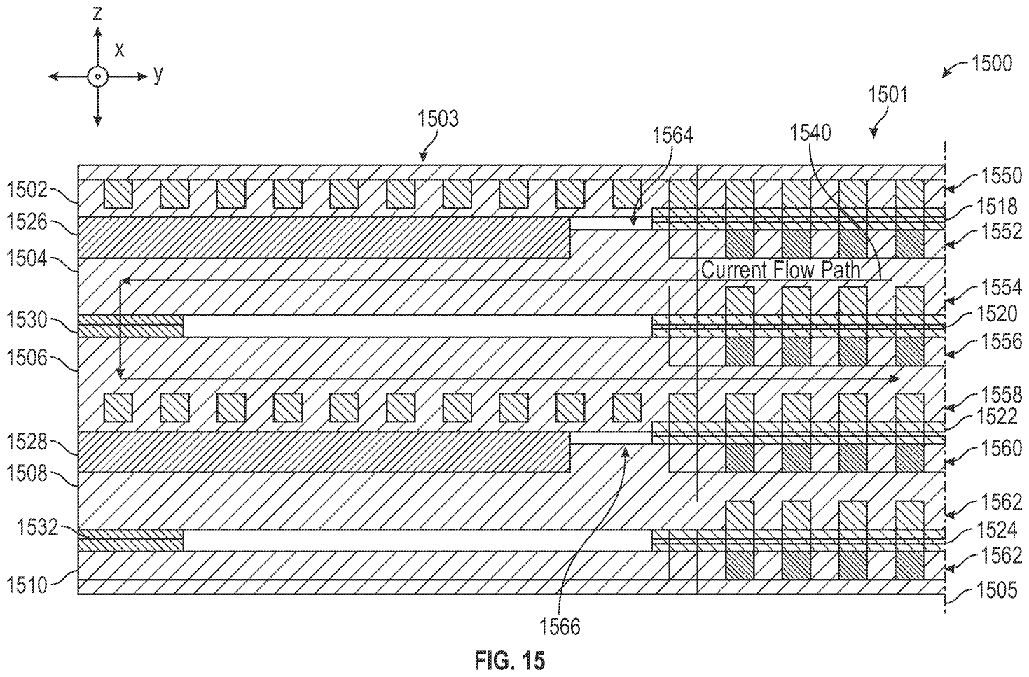

FIG. 15 is a diagram showing a cross-sectional view of a portion of an electrolyzer stack 1500 comprising five bipolar plates 1502, 1504, 1506, 1508, 1510. The cross-sectional view of the electrolyzer stack 1500 shown in FIG. 15 is along line 1505. Accordingly, FIG. 15 shows an edge 1503 and part of an interior portion 1501 of the electrolyzer stack.

In FIG. 15, a first electrolyzer cell comprises the bipolar plate 1502, the bipolar plate 1504, and an electrolytic membrane 1518 positioned therebetween at the interior portion 1501. A second electrolyzer cell comprises bipolar plate 1504, bipolar plate 1506, and an electrolytic membrane 1520 positioned therebetween at the interior portion 1501. A third electrolyzer cell comprises bipolar plate 1506, the bipolar plate 1508, and electrolytic membrane 1522 positioned therebetween. A fourth electrolyzer cell comprises bipolar plate 1508, bipolar plate 1510, and electrolytic membrane 1524 positioned therebetween.

The electrolyzer plate 1502 forms water flow channels 1550. The water flow channels 1550 may facilitate the flow of water along the X axis. The electrolyzer plate 1504 forms gas flow channels 1552. In some examples, water may flow through the flow channels 1550, react at the electrolytic membrane 1518 to form hydrogen and oxygen which is transported out of the electrolyzer stack 1500 via the gas flow channels 1552. The electrolyzer plates 1504, 1506, 1508, and 1510 may implement similar water flow channels 1554, 1558, 1562. Similarly, the electrolyzer plates 1504, 1506, 1508, and 1510 may implement similar gas flow channels 1552, 1556, 1560, and 1562.

The electrolyzer stack 1500 is arranged in a manner similar to that of the electrolyzer stack 1400 with switches and cooling mechanisms alternating along the Z axis on the edge 1503. For example, the first electrolyzer cell comprising bipolar plates 1502, 1504 may include one or more cooling mechanisms at the edge 1503. The second electrolyzer cell comprising bipolar plates 1504, 1506 comprises a switch 1530 therebetween at the edge 1503 implementing bypass circuitry for the second electrolyzer cell. In the example of FIG. 15, the switch 1530 is in a closed position that electrically coupled the bipolar plate 1504 and the bipolar plate 1506 causing a current flow path, indicated by arrow 1540, that shunts the electrolytic membrane 1520, thereby switching the second electrolyzer cell out of the stack.

The third electrolyzer cell comprising bipolar plates 1506, 1508 comprises one or more cooling mechanisms at the edge 1503. The fourth electrolyzer cell comprising bipolar plates 1508, 1510 comprises a switch 1532 therebetween at the edge 1503 implementing bypass circuitry for the fourth electrolyzer cell.

In some examples, the electrolyzer cells comprising bypass circuitry at the edge 1503 may comprise one or more cooling mechanisms at an opposite edge (not shown in FIG. 15) in the manner described with respect to the electrolyzer stack 1400. Similarly, the electrolyzer cells comprising cooling mechanisms at the edge 1503 may comprise bypass circuitry at the opposite edge.

In the example electrolyzer stack 1500, two cooling mechanisms are provided for each respective electrolyzer cell having cooling mechanisms at the edge 1503. For example, the water flow channels 1550 implemented by the bipolar plate 1502 may extend beyond the interior portion 1501 of the electrolyzer stack 1500 and into the edge 1503. Similarly, the water flow channels 1558 implemented by the bipolar plate 1506 may also extend beyond the interior portion 1501 of the electrolyzer stack 1500 and into the edge 1503. In this way, the extensions of the water flow channels may implement a cooling mechanism at the edge 1503.

The electrolyzer stack 1500 also comprises thermally dissipative and electrically insulating materials 1526, 1528 positioned, respectively, between the bipolar plates 1502, 1504 and 1506, 1508. The thermally dissipative and electrically insulating materials 1526, 1528 may implement an additional cooling mechanism at the edge 1503. In some examples, respective gaps 1564, 1566 are provided between the thermally dissipative and electrically insulating materials 1526, 1528 and the respective electrolytic membranes 1518, 1522.

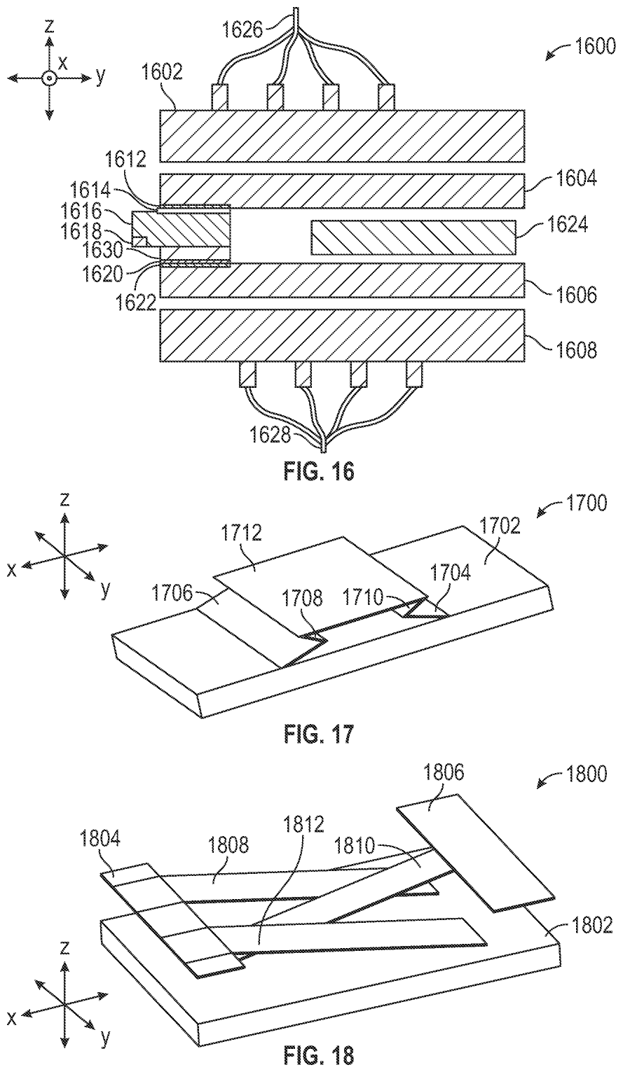

FIG. 16 is a diagram showing one example of an electrolyzer stack 1600 including bypass circuitry. The electrolyzer stack 1600 includes a single electrolyzer cell comprising bipolar plates 1604, 1606 and electrolyzer membrane 1624. The bipolar plates 1604, 1606 are electrically coupled to respective endplates 1602, 1608. The endplate 1602 receives a current at terminals 1626. Terminals 1628 of the endplate 1608 may be coupled to electrical ground. The bipolar plates 1604, 1606 and electrolytic membrane 1624 may implement an electrolyzer cell. Although one electrolyzer cell is implemented by the stack 1600, it will be appreciated that the arrangement may be utilized in stacks comprising more than one electrolyzer cell. The bipolar plates 1604, 1606 may be implemented using various bipolar plate arrangements described herein including, for example, bipolar plate 612, bipolar plate 802, and/or the bipolar plate 902.

A switch 1616 is positioned between the bipolar plates 1604, 1606. The switch 1616 may be switchable between a first state in which there is an open circuit between the bipolar plate 1604 and the bipolar plate 1606 and a second state in which the bipolar plate 1604 is electrically coupled to the bipolar plate 1606. The switch 1616 may be any suitable type of solid-state, space mechanical, or other suitable type of switch. In the example of FIG. 16, the switch 1616 may be a FET. A gate terminal 1618 of the FET is shown. For example, a control wire or other lead may be electrically coupled to the gate terminal 1618 to control the state of the switch 1616.

FIG. 16 also illustrates additional details for electrically coupling the switch 1616 between the bipolar plates 1604, 1606. For example, a coating 1612, 1622 may be positioned over portions of the bipolar plates 1604, 1606 that are bonded to the switch 1616. The coating may provide enhanced adhesion between the switch 1616 and the bipolar plates 1604, 1606. Any suitable coating may be used, such as for example, a nickel copper (Ni/Cu) coating.

For example, the bipolar plates 1604, 1606 may be made from a material, such as aluminum or titanium, that does not have favorable bonding properties with a bonding materials. A coating may be selected to bond with the material of the bipolar plates 1604, 1606 and also with a bonding material. In some examples, the coating may be copper and/or nickel. FIG. 16 also shows bonding material 1614, 1620 adhering the switch 1616 between the bipolar plates 1604, 1606. The bonding material may be any suitable conductive bonding materials such as, for example, a solder or a conductive adhesive, such as an epoxy.

In some examples, the distance between bipolar plates in an electrolyzer stack may not be consistent between electrolyzer cells. This may create challenges in placing a switch between two electrolyzer plates and keeping the switch in mechanical contact with both electrolyzer plates so as to electrically couple the plates when the switch is closed. Various examples can address this challenge by utilizing a resilient material between the switch 1616 and one or both of the bipolar plates 1604, 1606. In the example of FIG. 16, a resilient material 1630 is positioned between the switch 1616 and the bonding material 1620. In some examples, the resilient material is or includes a metal mesh or felt made from a conductive metal such as, for example, copper, aluminum, and/or the like. The resilient material may enhance adhesion an electrical connection between switches and bipolar plates, for example, when the switches and/or bipolar plates have variable flatness.

In some examples, challenges related to variable distance between bipolar plates may be addressed utilizing a switch comprising at least one contact that is resilient. For example, at least one contact may operate in a spring-like manner to place the contact in mechanical and electrical communication with a bipolar plate. FIG. 17 is a diagram showing one example of a switch 1700 comprising a resilient contact 1712. The switch 1700 comprises a body portion 1702. The body portion may house and/or embody various components of the switch 1700 such as, for example, a transistor or other solid-state switch, a contact or contacts for the transistor or other solid-state switch, and/or the like.

The resilient contact 1712 is mounted on panels 1704, 1706, 1708, 1710. The panels 1704, 1706, 1708, 1710 may be flexibly and resiliently joined to make the contact 1712 resilient along the Z axis. For example, when the switch 1700 is positioned between two bipolar plates, the resilient contact 1712 may be compressed in the direction of the negative Z axis. The panels may provide an opposite force in the direction of the positive Z axis to push the resilient contact 1712 into mechanical and electrical communication with a bipolar plate.

In some examples, the compliant contact 1712 and the flexible panels 1704, 1706, 1708, 1710 are formed from a single sheet of material that is folded to form the panels 1704, 1706, 1708, 1710. The material may be a metal such as, aluminum, copper, and/or the like.

FIG. 18 is a diagram showing one example of a switch 1800 comprising a resilient contact assembly comprising a first contact panel 1804 and a second contact panel 1806. The switch 1800 also includes a switch body portion 1802, which may be similar to the switch body portion 1702. A first panel 1804 of the resilient contact assembly is mechanically coupled to flexible arms 1808, 1812. A second panel 1806 of the resilient contact assembly is mechanically coupled to the flexible arm 1810. The flexible arms 1808, 1810, 1812 are resilient leave coupled to the switch body portion 1802. For example, when a force in the direction of the negative Z axis is exerted on the flexible arms 1808, 1810, 1812 or panels 1804, 1806, the flexible arms 1808, 1810, 1812 may resiliently exert an opposite force on the panels 1804, 1806 in the direction of the positive Z axis. When the switch 1800 is positioned between two bipolar plates, this may push the panels 1804, 1806 into mechanical and electrical contact with one of the bipolar plates.

The panels 1804, 1806 may be made from any suitable electrically conductive material such as aluminum, copper, and/or the like. The flexible arms 1808, 1810, 1812 may be made from any suitable electrically conductive or nonconductive material. In examples in which the flexible arms 1808, 1810, 1812 are made from an electrically nonconductive material, one or more conductive electrical traces may be included on two or more of the flexible arms 1808, 1810, 1812 to electrically couple the panels 1804, 1806 two the remainder of the switch at the switch body portion 1802. The flexible arms 1808, 1810, 1812 may be mechanically coupled to the respective panels 1804, 1806 in any suitable manner. The flexible arms 1808, 1810, 1812 may be mechanically coupled to the switch body portion 1802 in a resilient manner so as to resist forces in the direction of the negative Z axis, as described herein.

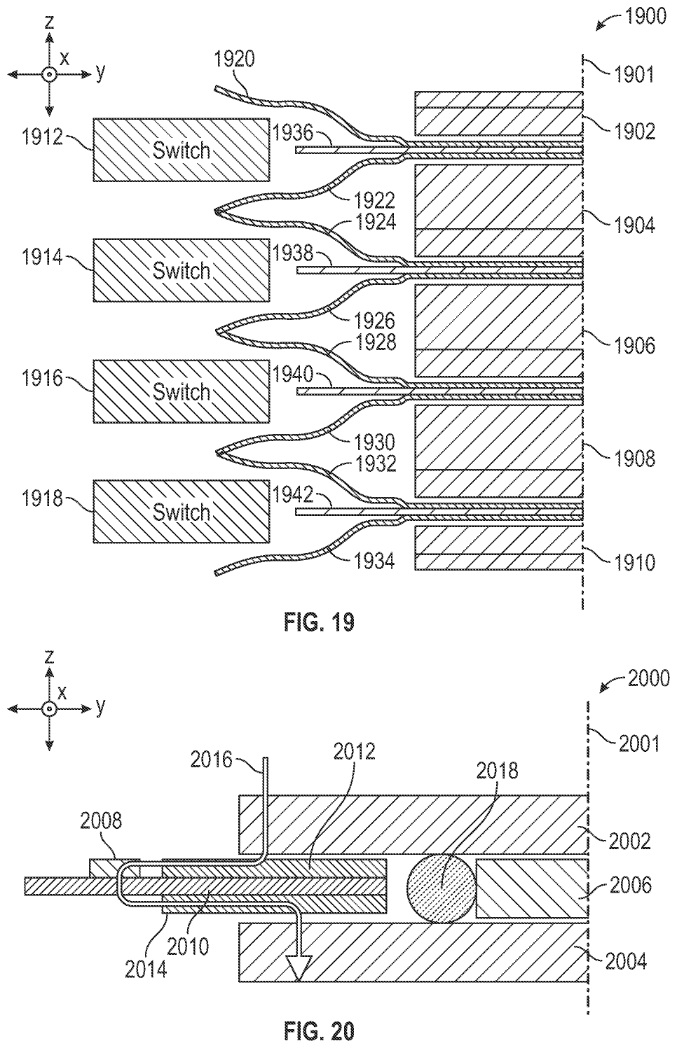

In some examples, bypass circuitry for an electrolyzer cell may be provided by a switch that is positioned outside of the edge of the respective bipolar plates. FIG. 19 is a diagram showing a cross-sectional view of a portion of one example of an electrolyzer stack 1900 comprising five bipolar plates 1902, 1904, 1906, 1908, 1910 stacked along the direction of the Z axis. Bypass circuitry is provided by switches 1912, 1914, 1916, 1918 that our position outside of the bipolar plates 1902, 1904, 1906, 1908, 1910. The cross-sectional view of the electrolyzer stack 1900 is along the line 1901. The bipolar plates 1902, 1904, 1906, 1908, 1910 may be or be similar to the various bipolar plate arrangements described herein including, for example, bipolar plate 612, bipolar plate 802, bipolar plate 902, bipolar plate 1200, and/or bipolar plate 1300.

The five bipolar plates 1902, 1904, 1906, 1908, 1910 implement four electrolyzer cells. A first electrolyzer cell is implemented between the bipolar plate 1902 and the bipolar plate 1904. A second electrolyzer cell is implemented between the bipolar plate 1904 and the bipolar plate 1906. A third electrolyzer cell is implemented between the bipolar plate 1906 and the bipolar plate 1908. A fourth electrolyzer cell is implemented between the bipolar plate 1908 and the bipolar plate 1910. Respective electrolytic membranes and other components may be included between the bipolar plates of the respective electrolyzer cells but are not specifically shown in FIG. 19.

Switch 1912 may be all or part of bypass circuitry for the first electrolyzer cell. The switch 1912 is positioned outside of the bipolar plates 1902, 1904 of the first electrolyzer cell. In this example, conductive sheets 1920, 1922 are positioned in mechanical and electrical communication with the respective bipolar plates 1902, 1904. For example, conductive sheet 1920 may be in mechanical and electrical communication with the bipolar plate 1902 and with the switch 1912. Conductive sheet 1922 may be in electrical and mechanical communication with the bipolar plate 1904 and with the switchs 1912, 1914. A thermally conductive electrically insulating sheet 1936 may be positioned between the conductive sheets 1920, 1922 to electrically insulate the conductive sheets 1920, 1922 from one another.

The conductive sheets 1920, 1922 may be formed from any suitable conductive material. For example, the sheets 1920, 1922 may be formed from a copper sheet or foil, and aluminum sheet or foil, or another suitable material. The conductive sheets 1920, 1922 may be of any suitable thickness. In some examples, the conductive sheets 1920, 1922 may be between about 50 um and 150 um in thickness.

The conductive sheets 1920, 1922 may be coextensive with the bipolar plates 1902, 1904 along the X axis, or may have a depth along the X axis that is less than that of the bipolar plates 1902, 1904. As shown in FIG. 19, a distance between the conductive sheets 1920, 1922 is larger than a distance between the respective bipolar plates 1902, 1904. In this way, the switch 1912 may have a larger dimension along the Z axis than a switch positioned between the bipolar plates 1902, 1904.

It will be appreciated that the switches 1914, 1916, 1918, conductive sheets 1924, 1926, 1928, 1930, 1932, 1934, and electrically insulating sheets 1936, 1938, 1940, 1942 may operate in a manner similar to that described herein with respect to the switch 1912, the conductive sheets 1920, 1922, and in the insulating sheet 1936.

FIG. 20 is a diagram showing one example of an electrolyzer cell 2000 comprising bypass circuitry including a switch 2008 positioned outside of bipolar plates 2002, 2004. The electrolyzer cell 2000 is also shown in cross-section along the line 2001. Bipolar plates 2002, 2004 include an electrolytic membrane 2006 positioned therebetween. A gasket 2018 completely or partially seals the electrolytic membrane 2006 from other components of the electrolyzer cell 2000.

The switch 2008 is positioned on a printed circuit board 2010 that is partially positioned between the bipolar plates 2002, 2004. The printed circuit board 2010 is mechanically and electrically coupled to the respective bipolar plates 2002, 2004 via leads 2012, 2014. Leads 2012, 2014 may be made from any suitable electrically conductive material. In some examples, leads 2012, 2014 may include a conductive adhesive, such as an epoxy, a solder, or other suitable material for electrically and mechanically coupling the printed circuit board 2010 to the bipolar plates 2002, 2004. Also, in some examples, leads 2012, 2013 may be or comprise a resilient material and/or a resilient contact, as described herein. The printed circuit board may comprise traces connecting the leads 2012, 2014 to contacts of the switch 2008. In some examples, the lead 2012 is electrically coupled to a first contact of the switch 2008 using a trace printed on a first side of the printed circuit board 2010. For example, the switch 2008 may be mounted on and/or otherwise in electrical communication with a suitable pad on the printed circuit board that is coupled to the lead 2012. In some examples, the lead 2014 is electrically coupled to a second contact of the switch 2008 via at least one printed trace and a through-hole via (not shown in FIG. 20). When the switch 2008 is closed, current may be shunted between the bipolar plates 2002, 2004 via the lead 2012, the switch 2008, and the lead 2014 as shown by arrow 2016.

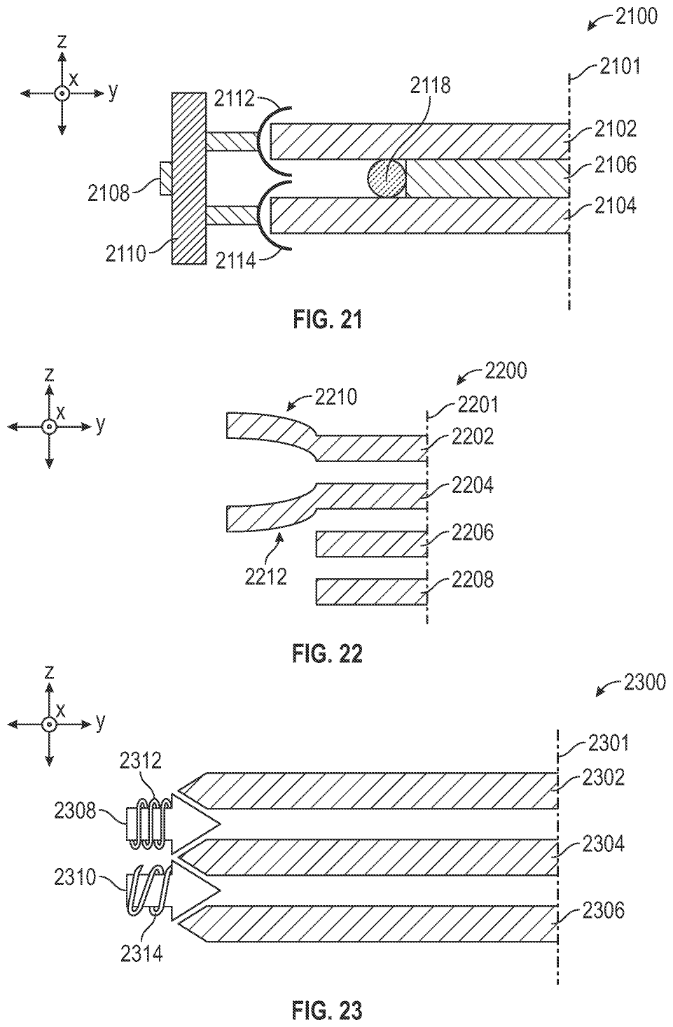

FIG. 21 is a diagram showing one example of an electrolyzer cell 2100 comprising bypass circuitry including a switch 2108 position outside of bipolar plates 2102, 2104. The electrolyzer cell 2100 is also shown in cross-section along the line 2101. Bipolar plates 2102, 2104 include an electrolytic membrane 2106 positioned therebetween. A gasket 2118 completely or partially seals the electrolytic membrane 2106 from other components of the electrolyzer cell 2100.

In the example of FIG. 21, the switch 2108 is mounted on a printed circuit board 2110. The printed circuit board 2110 is in electrical communication with the respective bipolar plates 2102, 2104 using connectors 2112, 2114. The printed circuit board 2110 may comprise various traces providing electrical connection between the connector 2112 and a first terminal of the switch 2108 as well as traces providing electrical connection between the connector 2114 and a second terminal of the switch 2108. When the switch 2108 is closed, current may be shunted between the bipolar plates to 2102, 2104. Via the connector 2112, the switch 2108, and the connector 2114.

FIG. 22 is a diagram showing selected components from an example electrolyzer stack 2200 including bipolar plates with fan out portions 2210, 2212. The electrolyzer stack 2200 is also shown in cross-section along a line 2201. The electrolyzer stack 2200 may include three electrolyzer cells. A first electrolyzer cell may comprise bipolar plates 2202 and 2204. A second electrolyzer cell may comprise bipolar plates 2204 and 2206. A third electrolyzer cell may comprise bipolar plates 2206 and 2208. Various components of the electrolyzer stack 2200 such as, for example, gaskets, electrolytic membranes, and/or the like are not shown in FIG. 22 but may be arranged as shown in other figures herein.

In this example, the bipolar plates 2202 and 2204 include respective fan out portions 2210 and 2212. A distance between the bipolar plates 2202, 2204 along the Z axis may be greater at the fan out portions 2210, 2212 than at other portions of the bipolar plates 2202, 2204. For example, the fan out portions may be electrically coupled to a switch (not shown in FIG. 22). This may facilitate the use of bypass circuitry comprising a switch that is larger than the distance between the bipolar plates 2202, 2204, such as illustrated by FIG. 19. In some examples, pairs of bipolar plates may comprise fan out portions on alternating sides of the electrolyzer stack 2200. For example, the pair of bipolar plates 2202, 2204 making up the first electrolytic cell are shown to have fan out portions 2210, 2212 on the illustrated side of the electrolyzer stack 2200, as shown. On an opposite side of the electrolyzer stack, in the direction of the positive Y axis from the line 2201, bipolar plates 2204, 2206 making up the second electrolyzer cell may have fan out portions (not shown).

In some examples, bypass circuitry may be provided between respective bipolar plates of an electrolyzer cell utilizing a mechanical switching arrangement. FIG. 23 is a diagram showing selected components from an example electrolyzer stack 2300 including bipolar plates 2302, 2304, 2306. The electrolyzer stack 2300 is also shown in cross-section along the line 2301. The electrolyzer stack 2300 may comprise two electrolyzer cells. A first electrolyzer cell comprises bipolar plate 2302 and bipolar plate 2304. A second electrolyzer cell comprises bipolar plate 2304 and bipolar plate 2306. Various components of the electrolyzer stack 2300 such as, for example, gaskets, electrolytic membranes, and/or the like are not shown in FIG. 23 but may be arranged as shown in other figures herein.

An electro-mechanical actuator 2308 is positioned to be selectively coupled mechanically and electrically to the bipolar plates 2302 and 2304. The mechanical actuator may be translatable along the Y axis. For example, the mechanical actuator 2308 may have a first position in which the mechanical actuator 2308 is translated away from the bipolar plates 2302, 2304 in the direction of the negative Y axis. In the first position, the mechanical actuator 2308 may not be in mechanical or electrical contact with the bipolar plates 2302, 2304. When the mechanical actuator 2308 is in the first position, the electrolyzer cell comprising the bipolar plate 2302 and the bipolar plate 2304 may be operative or not bypassed. The mechanical actuator 2308 may also have a second position in which it is translated towards the bipolar plates 2302, 2304 in the direction of the positive Y axis. In this position, the mechanical actuator 2308 may be mechanically and electrically coupled to the bipolar plates 2302, 2304.

The mechanical actuator 2308 may have beveled leading edges that match corresponding baffles in the bipolar plates 2302, 2304 so as to increase the surface area of the mechanical actuator 2308 in physical and electrical contact with the bipolar plates 2302, 2304. The mechanical actuator 2308 may be made of and/or comprise an electrically conductive material, such as, copper or another suitable metal. In this way, when the mechanical actuator 2308 is in mechanical contact with the bipolar plates 2302, 2304 it may electrically couple the bipolar plates 2302, 2304 so as to shunt electrical current through the mechanical actuator 2308 and thereby bypass the first electrolyzer cell.

FIG. 23 also shows a spring 2312. The spring 2312 may be positioned as shown to provide a force on the mechanical actuator 2308 in the direction of the positive Y axis. In this way, the mechanical actuator 2308 may be pulled back in the direction of the negative Y axis when the first electrolyzer cell is in operation. When the first electrolyzer cell is to be bypassed, the spring 2312 may provide a force tending to move the mechanical actuator 2308 into contact with the bipolar plates 2302, 2304 in the direction of the positive Y axis. FIG. 23 also shows a mechanical actuator 2310 and spring 2314 that may operate in a similar manner with respect to the bipolar plates 2304, 2306 of the second electrolyzer cell. Also, in some examples, and electromechanical mechanism may be provided to selectively move one or more of the mechanical actuator 2308, 2310 in the direction of the positive Y axis or in the direction of the negative Y axis.

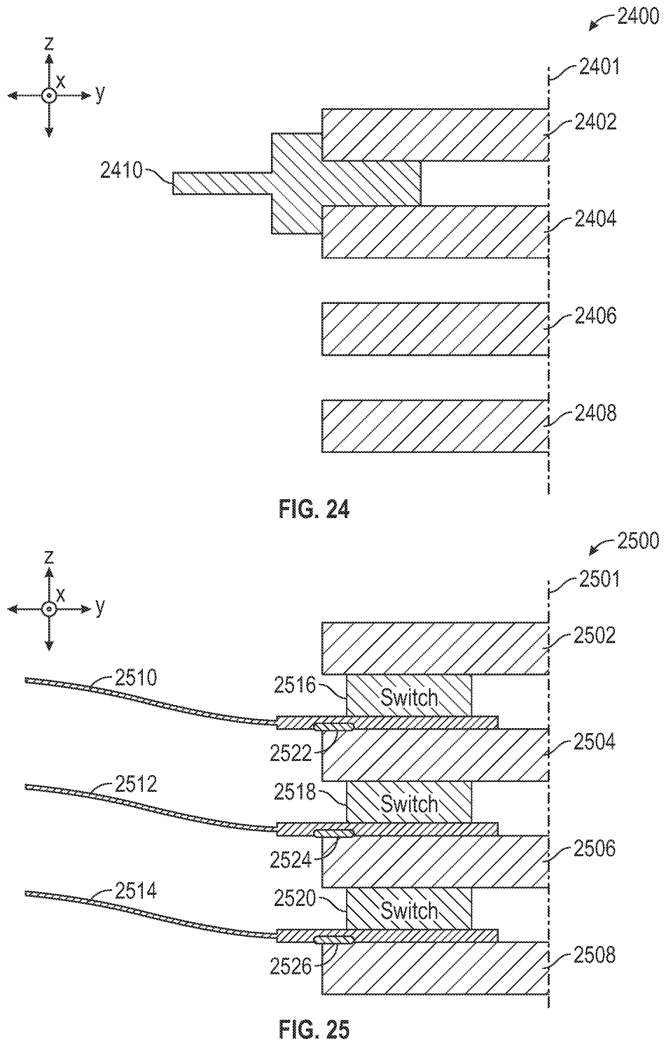

FIG. 24 is a diagram showing selected components from an example electrolyzer stack 2400 including bipolar plates 2402, 2404, 2406, 2408. The electrolyzer stack 2400 is also shown in cross-section along the line 2401. The electrolyzer stack 2400 may comprise three electrolyzer cells. A first electrolyzer cell comprises bipolar plate 2402 and bipolar plate 2404. A second electrolyzer cell comprises bipolar plate 2404 and bipolar plate 2406. A third electrolyzer cell comprises bipolar plate 2406 and bipolar plate 2408. Various components of the electrolyzer stack 2400 such as, for example, gaskets, electrolytic membranes, and/or the like are not shown in FIG. 24 but may be arranged as shown in other figures herein.

The example of FIG. 24 comprises a conductive plug 2410 that may be selectively positioned between any two of the bipolar plates 2402, 2404, 2406, 2408. The conductive plug 2410 may be made of and/or coated with a conductive material such as, for example, copper. In the arrangement shown in FIG. 24, the conductive plug 2410 electrically couples the bipolar plate 2402 to the bipolar plate 2404, thereby bypassing the first electrolyzer cell. Although one conductive plug 2410 is shown in FIG. 24, it will be appreciated that multiple conductive plugs may be used to bypass multiple electrolyzer cells. In some examples, the conductive plug may be positioned manually and or by a suitable mechanism. In some examples, multiple mechanical plugs may be joined into a common component that can be selectively inserted or removed from between the bipolar plates 2402, 2404, 2406, 2408.

FIG. 25 is a diagram showing a cross-sectional view of a portion of an example electrolyzer stack 2500 comprising four bipolar plates 2502, 2504, 2506, 2508 stacked along the Z axis and including bypass circuitry mounted on respective flexible printed circuit boards 2510, 2512, 2514. Bypass circuitry is provided by switches 2516, 2518, 2520. The cross-sectional view of the electrolyzer stack 2500 is along the line 2501. The bipolar plates 2502, 2504, 2506, 2508 may be or be similar to the various bipolar plate arrangements described herein including, for example, bipolar plate 612, bipolar plate 802, bipolar plate 902, bipolar plate 1200, and/or bipolar plate 1300.

The four bipolar plates 2502, 2504, 2506, 2508 implement three electrolyzer cells. A first electrolyzer cell is implemented between the bipolar plate 2502 and the bipolar plate 2504. A second electrolyzer cell is implemented between the bipolar plate 2504 and the bipolar plate 2506. A third electrolyzer cell is implemented between the bipolar plate 2506 and the bipolar plate 2508. Respective electrolytic membranes and other components may be included between the bipolar plates of the respective electrolyzer cells but are not specifically shown in FIG. 25.

In the example of FIG. 25, switches 2516, 2518, 2520 are mounted on respective flexible printed circuit boards 2510, 2512, 2514. Flexible printed circuit boards 2510, 2512, 2514 may be made from any suitable material such as, for example, a polyamide. For example, the switch 2516 may be surface mounted to the flexible printed circuit board 2510. A first contact of the switch 2516 may be in mechanical and electrical communication with the bipolar plate 2502. A second contact of the switch 2516 may be in mechanical and electrical communication with a surface mount pad on the flexible printed circuit board 2510. The flexible printed circuit board 2510 may comprise one or more printed traces coupling the second contact of the switch 2516 to a pad 2522 that is in mechanical and electrical contact with the bipolar plate 2504. In some examples, the one or more printed traces coupling the second contact of the switch 2516 to the pad 2522 may comprise a through hole via. In some examples, the flexible printed circuit boards 2512, 2514 and pads 2524 and 2526 may be similarly arranged. In some examples, flexible printed circuit boards may be thinner than rigid printed circuit boards. Accordingly, an arrangement such as the one shown in FIG. 25 may allow for the switches 2516, 2518, 2520 to be positioned between the bipolar plates 2502, 2504, 2506, 2508, as shown, with less space between the bipolar plates 2502, 2504, 2506, 2508.

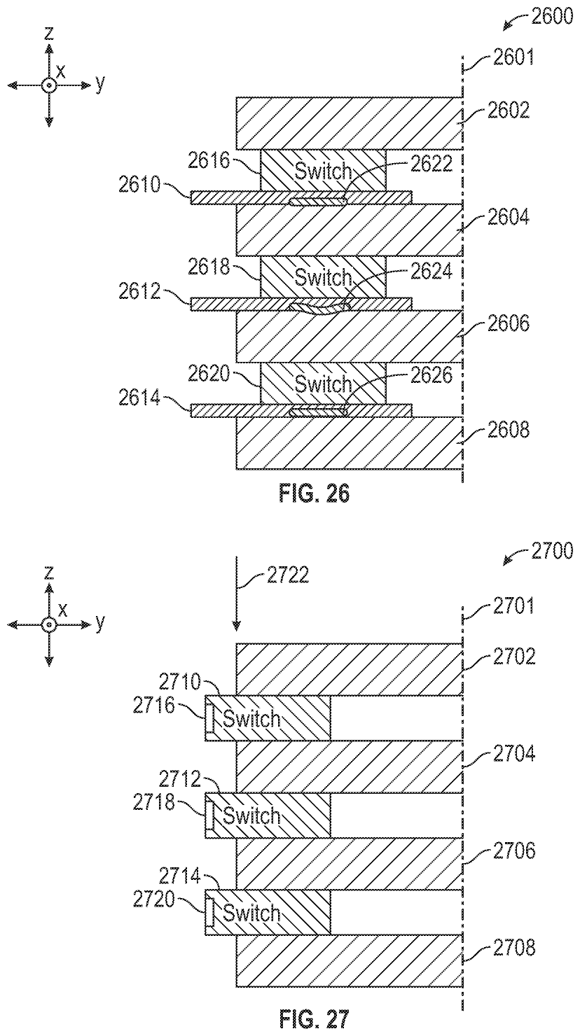

FIG. 26 is a diagram showing a cross-sectional view of a portion of an example electrolyzer stack 2600 comprising four bipolar plates 2602, 2604, 2606, 2608 stacked along the Z axis and including bypass circuitry mounted on respective rigid printed circuit boards 2610, 2612, 2614. Bypass circuitry is provided by switches 2616, 2618, 2620. The cross-sectional view of the electrolyzer stack 2600 is along the line 2601. The bipolar plates 2602, 2604, 2606, 2608 may be or be similar to the various bipolar plate arrangements described herein including, for example, bipolar plate 612, bipolar plate 802, bipolar plate 902, bipolar plate 1200, and/or bipolar plate 1300.

The four bipolar plates 2602, 2604, 2606, 2608 implement three electrolyzer cells. A first electrolyzer cell is implemented between the bipolar plate 2602 and the bipolar plate 2604. A second electrolyzer cell is implemented between the bipolar plate 2604 and the bipolar plate 2606. A third electrolyzer cell is implemented between the bipolar plate 2606 and the bipolar plate 2608. Respective electrolytic membranes and other components may be included between the bipolar plates of the respective electrolyzer cells but are not specifically shown in FIG. 26.

In the example of FIG. 26, switches 2616, 2618, 2620 are mounted on respective printed circuit boards 2610, 2612, 2614. Printed circuit boards 2610, 2612, 2614 may be rigid. The switch 2616 may be surface mounted to the printed circuit board 2610. A first contact of the switch 2616 may be in mechanical and electrical communication with the bipolar plate 2602. A second contact of the switch 2616 may be in mechanical and electrical communication with a service mount pad on the printed circuit board 2610. The printed circuit board 2610 may comprise one or more printed traces coupling the second contact of the switch 2616 to a pad 2622 that is in mechanical and electrical contact with the bipolar plate 2604. In some examples, the one or more printed traces coupling the second contact of the switch 2616 to the pad 2622 may comprise a through hole via. In some examples, the printed circuit boards 2612, 2614 and pads 2624 and 2626 may be similarly arranged. Rigid circuit boards, such as shown in FIG. 26, may provide more structural support to the respective switches 2616, 2618, 2620 and the electrolyzer stack 2600, but may be thicker than flexible printed circuit boards 2510, 2512, 2514. The use of circuit boards as shown in FIGS. 25 and 26 may, in some examples, facilitate consistent connections between the switches and one or more controllers. In some examples, this may facilitate proper timing and distribution of signals between a controller and the switches.

FIG. 27 is a diagram showing a cross-sectional view of a portion of an example electrolyzer stack 2700 comprising four bipolar plates 2702, 2704, 2706, 2708 stacked along the Z axis. Bypass circuitry is provided by switches 2710, 2712, 2714. The cross-sectional view of the electrolyzer stack 2700 is along the line 2701. The bipolar plates 2702, 2704, 2706, 2708 may be or be similar to the various bipolar plate arrangements described herein including, for example, bipolar plate 612, bipolar plate 802, bipolar plate 902, bipolar plate 1200, and/or bipolar plate 1300.

The four bipolar plates 2702, 2704, 2706, 2708 implement three electrolyzer cells. A first electrolyzer cell is implemented between the bipolar plate 2702 and the bipolar plate 2704. A second electrolyzer cell is implemented between the bipolar plate 2704 and the bipolar plate 2706. A third electrolyzer cell is implemented between the bipolar plate 2706 and the bipolar plate 2708. Respective electrolytic membranes and other components may be included between the bipolar plates of the respective electrolyzer cells but are not specifically shown in FIG. 27.

In the example of FIG. 27 switches 2710, 2712, 2714 are positioned between respective bipolar plates 2702, 2704, 2706, 2708. Switches 2710, 2712, 2714 extend beyond a perimeter of the bipolar plates 2702, 2704, 2706, 2708. The perimeter of the bipolar plates 2702, 2704, 2706, 2708 is indicated by arrow 2722. As shown, switches 2710, 2712, 2714 extend in the direction of the negative Y axis beyond the perimeter of the bipolar plates 2702, 2704, 2706, 2708 indicated by the arrow 2722.

In this example, the switches 2710, 2712, 2714 comprise respective contacts 2716, 2718, 2720 positioned on portions of the respective switches 2710, 2712, 2714 that extend in the direction of the negative Y axis beyond the perimeter indicated by the arrow 2722. The contacts 2716, 2718, 2720 may actuate the respective switches 2710, 2712, 2714 when an appropriate electrical signal is provided. For example, when the switches 2710, 2712, 2714 are or include solid-state switches, the contacts 2716, 2718, 2720 may be electrically coupled to the respective gates, bases, or other suitable terminals of the solid-state switches. In this way, wiring connecting the switches 2710, 2712, 2714 to a controller may not need to extend between the bipolar plates 2702, 2704, 2706, 2708.

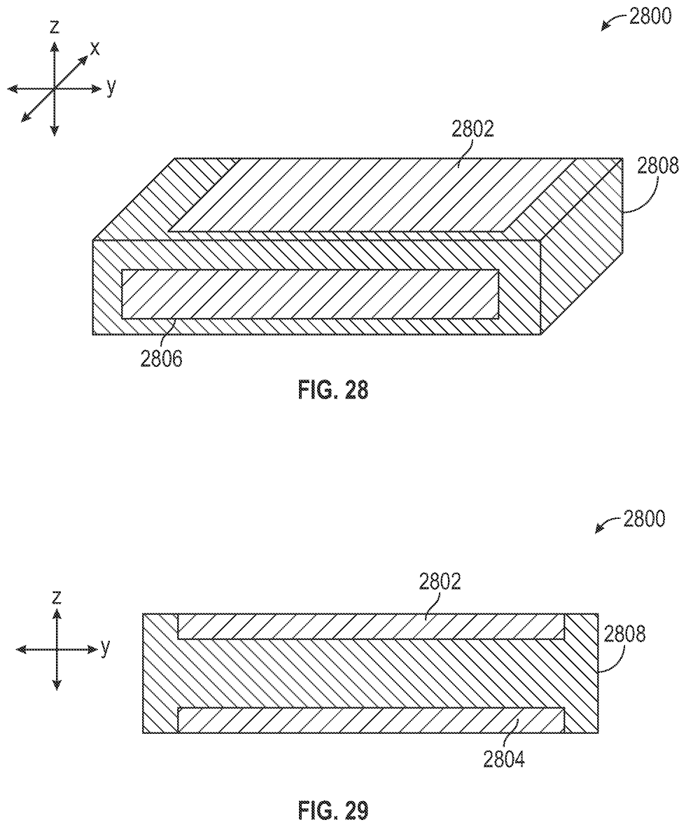

FIGS. 28 and 29 show an example switch 2800 that may be used to implement bypass circuitry, as described herein. The switch 2800 may comprise a packaging 2808. The packaging may house a solid-state switch such as a FET or bipolar transistor. The switch 2800 also includes terminal contacts 2802, 2804, and 2806. Terminal contacts 2802 and 2804 may be positioned to establish mechanical and electrical contact with respective bipolar plates, for example, as described herein. For example, the switch 2800 may be positioned between a first bipolar plate and a second bipolar plate. The first bipolar plate may be positioned in the direction of the positive Z axis relative to the switch 2800. The second bipolar plate may be positioned in the direction of the negative Z axis relative to the switch 2800. Accordingly, the terminal contact 2802 may be in mechanical and electrical contact with the first bipolar plate and the terminal contact 2804 may be in electrical and mechanical contact with the second bipolar plate. The terminal contact 2186 may be positioned to face toward a perimeter of the bipolar plates.

In some examples, the terminal contacts 2802, 2804 may be electrically coupled to the drain and source contacts of a FET and/or the emitter and collector of a bipolar transistor, respectively. The terminal contact 2806 may be electrically coupled to a control contact of the solid-state switch such as, for example, the gate of a FET or the base of a bipolar transistor.

In some examples, the switches for switching electrolyzer cells into and out of a single electrolyzer stack may be controlled by a single control circuit, such as, for example, control circuitry 330 of FIG. 3, control circuitry 530 of FIG. 5, or by multiple local controllers such as, for example, control circuit 210 of FIG. 2. In some examples, a controller or controller may electrically remove damaged cells from the electrolyzer stack by closing one or more switches two electrically couple the bipolar plates of the damaged cell, thereby shunting current around the damaged cell.

In some examples one or more switches may be operated in a linear mode. When operated in a linear mode, a switch may shunt some, but not all, of the current provided to the cell. In this way, some, but not all, of the current provided to the cell may be used to generate hydrogen while a remainder of the current is shunted. This may be used, for example, to avoid overheating of electrolyzer cells. For example, when the one or more controllers receive an indication that an electrolyzer cell is overheating or is at risk of overheating, the one or more controllers may operate one or more switches at the electrolyzer cell in a linear mode to shunt a portion of the provided current.

Also, in some examples, switches between electrolyzer cell bipolar plates may be utilized as a heater to accelerate the heating of water provided via water flow channels. For example, current shunted between bipolar plates may cause heating in the bipolar plate. As the bipolar plate heats, it may also heat water being provided via one or more water flow channels (e.g., water flow channels 1550, 1554, 1558, 1562). When the water reaches operating temperature, the switches may be opened. Operating temperature may be, for example, between about 60° C. and about 100° C. such as, for example, about 80° C.

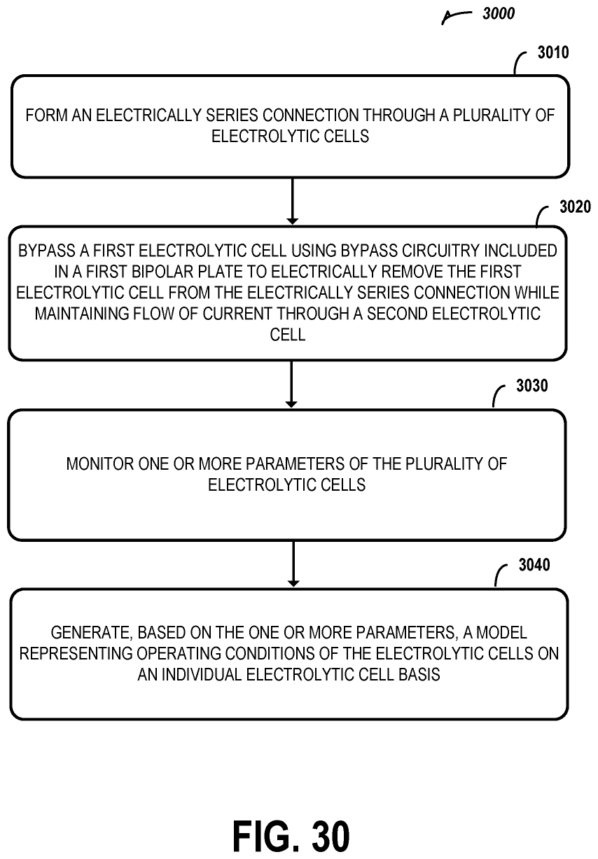

In some examples, switching assemblies, as described herein, may be utilized to permit hot swapping of electrolyzer cells and/or components thereof. For example, the bipolar plates of an electrolyzer cell may be electrically coupled while components of the cell, such as the electrolytic membrane, are swapped and replaced. FIG. 30 is a flow diagram depicting example process 3000 for operating or configuring an electrolyzer, in accordance with various embodiments. The operations of the process 3000 may be performed in parallel or in a different sequence or may be entirely omitted. In some embodiments, some or all of the operations of the process 3000 may be embodied on a computer-readable medium and executed by one or more processors.

At operation 3010, an electrolyzer forms an electrical series connection through a plurality of electrolyzer cells.

At operation 3020, control circuitry bypasses a first electrolyzer cell of the plurality of electrolyzer cell using bypass circuitry included in a first bipolar plate to electrically remove the first electrolyzer cell from the electrical series connection while maintaining flow of current through a second electrolyzer cell.

At operation 3030, the control circuitry monitors one or more parameters of the plurality of electrolyzer cells.

At operation 3040, the control circuitry generates a model, based on the one or more parameters, representing operating conditions of the electrolyzer cells on an individual electrolyzer cell basis.

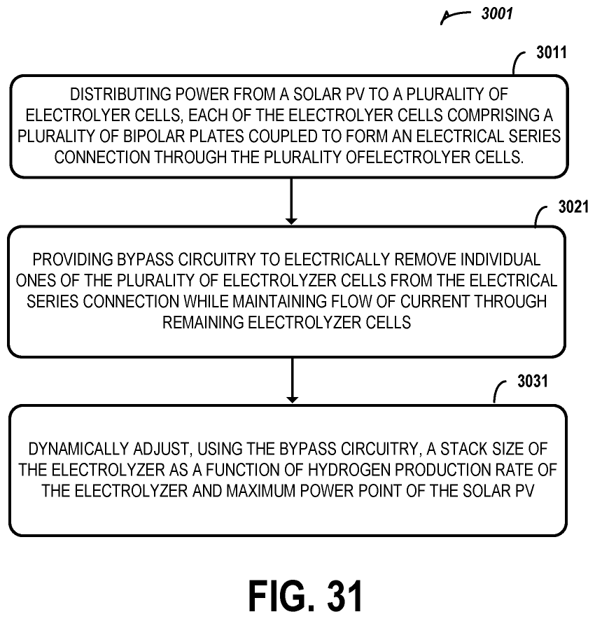

FIG. 31 is a flow diagram depicting example process 3001 for operating or configuring an electrolyzer coupled to a solar PV, in accordance with various embodiments. The operations of the process 3001 may be performed in parallel or in a different sequence or may be entirely omitted. In some embodiments, some or all of the operations of the process 3001 may be embodied on a computer-readable medium and executed by one or more processors.

At operation 3011, a solar PV distributes power to a plurality of electrolyzer cells, each of the electrolyzer cells comprising a plurality of bipolar plates coupled to form an electrical series connection through a plurality of electrolyzer cells.

At operation 3021, bypass circuitry is provided to electrically remove individual ones of the plurality of electrolyzer cells from the electrical series connections while maintaining flow of current through remaining electrolyzer cells.

At operation 3031, the control circuitry dynamically adjusts, using the bypass circuitry, a stack size of the electrolyzer as a function of hydrogen production rate of the electrolyzer and maximum power point of the solar PV.

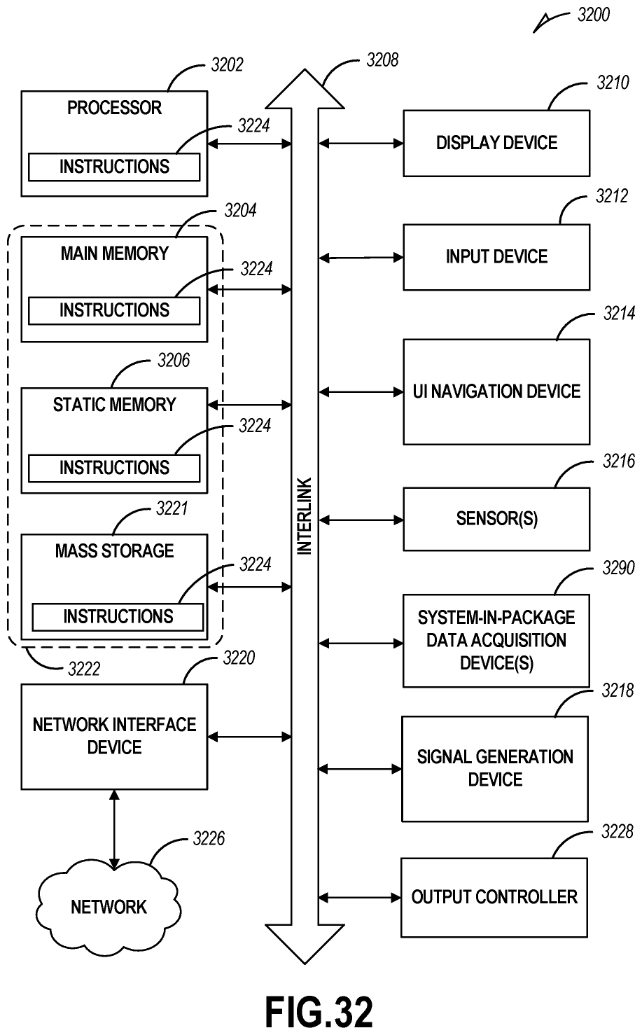

FIG. 32 is a block diagram of an example machine 3200 upon which any one or more of the techniques (e.g., methodologies) discussed herein may be performed. In alternative embodiments, the machine 3200 may operate as a standalone device or may be connected (e.g., networked) to other machines. In a networked deployment, the machine 3200 may operate in the capacity of a server machine, a client machine, or both in server-client network environments. In an example, the machine 3200 may act as a peer machine in a peer-to-peer (P2P) (or other distributed) network environment. The machine 3200 may be a personal computer (PC), a tablet PC, a set-top box (STB), a personal digital assistant (PDA), a mobile telephone, a web appliance, an IoT device, an automotive system, an aerospace system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant-massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 3200 may include a hardware processor 3202 (e.g., a central processing unit (CPU), a graphics processing unit (GPU), a hardware processor core, or any combination thereof, such as a memory controller, etc.), a main memory 3204, and a static memory 3206, some or all of which may communicate with each other via an interlink (e.g., bus) 3208. The machine 3200 may further include a display device 3210, an alphanumeric input device 3212 (e.g., a keyboard), and a user interface (UI) navigation device 3214 (e.g., a mouse). In an example, the display device 3210, alphanumeric input device 3212, and UI navigation device 3214 may be a touchscreen display. The machine 3200 may additionally include a storage device 3222 (e.g., drive unit); a signal generation device 3218 (e.g., a speaker); a network interface device 3220; one or more sensors 3216, such as a Global Positioning System (GPS) sensor, wing sensor, mechanical device sensor, temperature sensor, bridge sensor, audio sensor, industrial sensor, a compass, an accelerometer, or other sensors; and one or more system-in-package data acquisition devices 3290. The system-in-package data acquisition device(s) 3290 may implement some or all of the functionality of the electrolyzer systems, discussed above. The machine 3200 may include an output controller 3228, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The storage device 3222 may include a machine-readable medium on which is stored one or more sets of data structures or instructions 3224 (e.g., software) embodying or utilized by any one or more of the techniques or functions described herein. The instructions 3224 may also reside, completely or at least partially, within the main memory 3204, within the static memory 3206, or within the hardware processor 3202 during execution thereof by the machine 3200. In an example, one or any combination of the hardware processor 3202, the main memory 3204, the static memory 3206, or the storage device 3222 may constitute the machine-readable medium.

While the machine-readable medium is illustrated as a single medium, the term “machine-readable medium” may include a single medium or multiple media (e.g., a centralized or distributed database, or associated caches and servers) configured to store the one or more instructions 3224.

The term “machine-readable medium” may include any transitory or non-transitory medium that is capable of storing, encoding, or carrying transitory or non-transitory instructions for execution by the machine 3200 and that cause the machine 3200 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 3224 (e.g., software, programs, an operating system (OS), etc.) or other data that are stored on the storage device 3221 can be accessed by the main memory 3204 for use by the hardware processor 3202. The main memory 3204 (e.g., DRAM) is typically fast, but volatile, and thus a different type of storage from the storage device 3221 (e.g., an SSD), which is suitable for long-term storage, including while in an “off” condition. The instructions 3224 or data in use by a user or the machine 3200 are typically loaded in the main memory 3204 for use by the hardware processor 3202. When the main memory 3204 is full, virtual space from the storage device 3221 can be allocated to supplement the main memory 3204; however, because the storage device 3221 is typically slower than the main memory 3204, and write speeds are typically at least twice as slow as read speeds, use of virtual memory can greatly reduce user experience due to storage device latency (in contrast to the main memory 3204, e.g., DRAM). Further, use of the storage device 3221 for virtual memory can greatly reduce the usable lifespan of the storage device 3221.

The instructions 3224 may further be transmitted or received over a communications network 3226 using a transmission medium via the network interface device 3220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, P2P networks), among others. In an example, the network interface device 3220 may include one or more physical jacks (e.g., Ethernet, coaxial, or phone jacks) or one or more antennas to connect to the communications network 3226. In an example, the network interface device 3220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any tangible or intangible medium that is capable of storing, encoding, or carrying instructions for execution by the machine 3200, and includes digital or analog communications signals or other tangible or intangible media to facilitate communication of such software.

Each of the non-limiting aspects or examples described herein may stand on its own or may be combined in various permutations or combinations with one or more of the other examples.

The above detailed description includes references to the accompanying drawings, which form a part of the detailed description. The drawings show, by way of illustration, specific embodiments in which the inventive subject matter may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended; that is, a system, device, article, composition, formulation, or process that includes elements in addition to those listed after such a term in an aspect are still deemed to fall within the scope of that aspect. Moreover, in the following aspects, the terms “first,” “second,” “third,” and so forth are used merely as labels and are not intended to impose numerical requirements on their objects.

Method examples described herein may be machine- or computer-implemented at least in part. Some examples may include a computer-readable medium or machine-readable medium encoded with transitory or non-transitory instructions operable to configure an electronic device to perform methods as described in the above examples. An implementation of such methods may include code, such as microcode, assembly-language code, a higher-level-language code, or the like. Such code may include transitory or non-transitory computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read-only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above detailed description, various features may be grouped together to streamline the disclosure. This should not be interpreted as intending that a disclosed feature not listed in the list of claims is essential to any aspect. Rather, inventive subject matter may lie in less than all features of a particular disclosed embodiment. Thus, the following aspects are hereby incorporated into the detailed description as examples or embodiments, with each claim standing on its own as a separate embodiment, and it is contemplated that such embodiments may be combined with each other in various combinations or permutations. The scope of the inventive subject matter should be determined with reference to the appended claims, along with the full scope of equivalents to which such claims are entitled.

1. An electrolyzer system comprising:
an electrolyzer stack, the electrolyzer stack comprising:
a first bipolar plate;
a second bipolar plate parallel to the first bipolar plate;
a third bipolar plate parallel to the second bipolar plate;
a first switch electrically coupled between the first bipolar plate and the second bipolar plate to selectively electrically couple the first bipolar plate and the second bipolar plate; and
a second switch electrically coupled between the second bipolar plate and the third bipolar plate to selectively electrically couple the second bipolar plate and the third bipolar plate; and
a controller circuit, the controller circuit configured to actuate the first switch to electrically couple the first bipolar plate and the second bipolar plate.

2. The electrolyzer system of claim 1, the electrolyzer stack having a first edge and a second edge opposite the first edge, the first switch being positioned between the first bipolar plate and the second bipolar plate at the first edge, and the second switch being positioned between the second bipolar plate and the third bipolar plate at the second edge.

3. The electrolyzer system of claim 2, the electrolyzer stack further comprising an extension of a flow channel positioned between the first bipolar plate and the second bipolar plate at the second edge.

4. The electrolyzer system of claim 2, the electrolyzer stack further comprising a material that is thermally dissipative and electrically insulating positioned between the first bipolar plate and the second bipolar plate at the second edge.

5. The electrolyzer system of claim 2, the electrolyzer stack further comprising a gasket positioned between the first bipolar plate and the second bipolar plate at the first edge, the first switch being positioned outside the gasket.

6. The electrolyzer system of claim 1, the first switch being mechanically coupled to the first bipolar plate using at least one of a conductive adhesive, a solder, or a metal mesh.

7. The electrolyzer system of claim 5, the first switch being mechanically coupled to a portion of the first bipolar plate using solder, the portion of the first bipolar plate comprising a coating.

8. The electrolyzer system of claim 1, the first switch being positioned between the first bipolar plate and the second bipolar plate, the first switch comprising a resilient structure arranged to exert a first force against the first bipolar plate and a second force against the second bipolar plate.

9. The electrolyzer system of claim 1, the electrolyzer stack further comprising:
a first conductive foil electrically coupled to the first bipolar plate;
a second conductive foil electrically coupled to the second bipolar plate; and
an insulator material positioned between the first conductive foil and the second conductive foil, the first switch being electrically coupled between the first conductive foil and the second conductive foil.

10. The electrolyzer system of claim 9, a distance between the first conductive foil and the second conductive foil at the first switch being greater than a distance between the first bipolar plate and the second bipolar plate.

11. The electrolyzer system of claim 1, the first switch comprising a mechanical actuator member arranged to be selectively positioned between the first bipolar plate and the second bipolar plate.

12. The electrolyzer system of claim 1, the electrolyzer stack further comprising a printed circuit board, the first switch being mounted on the printed circuit board.

13. The electrolyzer system of claim 12, the printed circuit board comprising a first contact on a first side of the printed circuit board and a second contact on a second side of the printed circuit board, the printed circuit board being positioned between the first bipolar plate and the second bipolar plate with the first contact electrically coupled to the first bipolar plate and the second contact electrically coupled to the second bipolar plate.

14. The electrolyzer system of claim 12, further comprising a connector to electrically couple the printed circuit board to the first bipolar plate and the second bipolar plate.

15. The electrolyzer system of claim 12, the printed circuit board being a flexible printed circuit board, a first portion of the printed circuit board being between the first bipolar plate and the second bipolar plate, and a second portion of the printed circuit board not being between the first bipolar plate and the second bipolar plate.

16. The electrolyzer system of claim 12, the printed circuit board comprising a first contact on a first side, the first switch being mounted to the printed circuit board on a second side of the printed circuit board, the first contact being electrically coupled to the first bipolar plate and at least a portion of the first switch being electrically coupled to the second bipolar plate.

17. The electrolyzer system of claim 1, the first switch comprising a packaging having a first side and a second side, a first terminal being positioned on the first side and in contact with the first bipolar plate and a second terminal being positioned on the second side and in contact with the second bipolar plate.

18. The electrolyzer system of claim 1, the controller circuit being programmed to perform operations comprising:
closing the first switch and the second switch;
after closing the first switch and the second switch, receiving an indication that water in the electrolyzer stack has reached a threshold temperature; and
opening the first switch and the second switch.

19. An electrolyzer system comprising:
an electrolyzer stack, the electrolyzer stack comprising:
a first bipolar plate;
a second bipolar plate parallel to the first bipolar plate;
a third bipolar plate parallel to the second bipolar plate;
first means for selectively electrically coupling the first bipolar plate and the second bipolar plate; and
second means for selectively electrically coupling the second bipolar plate and the third bipolar plate.

20. The electrolyzer system of claim 19, further comprising controller circuit being programmed to perform operations comprising:
configuring the first means to electrically couple the first bipolar plate and the second bipolar plate;
configuring the second means to electrically couple the second bipolar plate and the third bipolar plate;
receiving an indication that water in the electrolyzer stack has reached a threshold temperature;
after receiving the indication that water in the electrolyzer stack has reached the threshold temperature, configuring the first means to remove electrical coupling between the first bipolar plate and the second bipolar plate; and
after receiving the indication that water in the electrolyzer stack has reached the threshold temperature, configuring the second means to remove electrical coupling between the second bipolar plate and the third bipolar plate.
